(19) United States
(12) Patent Application Publication
(10) Pub. No.: US 2019/0005171 A1
(43) Pub. Date: Jan. 3, 2019

(54) Method for constructing finite element interpolation function

(71) Applicant: Central South University, Changsha, Hunan (CN)

(72) Inventors: Guoxiang Zhang, Changsha, Hunan (CN); Fanhang Zhang, Changsha, Hunan (CN)

(21) Appl. No.: 15/749,021

(22) PCT Filed: Jun. 1, 2017
(86) PCT No.: PCT/CN2017/086830

§ 371 Date: Jan. 30, 2018

(30) Foreign Application Priority Data
Apr. 26, 2017 (CN) 201710307000.X

(51) Int. Cl. G06F 17/50; G06F 17/11

(52) U.S. Cl. CPC G06F 17/5018; G06F 17/11

(57) ABSTRACT

A method for constructing a finite element interpolation function and a system thereof are provided, relating to a technical field of analog simulation, so as to improve performance of the interpolation function. The method includes steps of: constructing an interpolation function through a hybrid coordinate system formed by a linear transformation coordinate system and an isoparametric coordinate system; and according to characteristics of a target solid element, determining a coordinate variable number, a term number and an order of the interpolation function, wherein: the characteristics of the target solid element include a known node number and a known node displacement component number; and, the term number of the constructed interpolation function is equal to a total displacement number of related interpolation nodes of the target solid element.

### CROSS REFERENCE OF RELATED APPLICATION

This is a U.S. National Stage under 35 U.S.C 371 of the International Application PCT/CN2017/086830, filed Jun. 1, 2017, which claims priority under 35 U.S.C. 119(a-d) to CN 201710307000.X, filed Apr. 26, 2017.

### BACKGROUND OF THE PRESENT INVENTION

### Field of Invention

The present invention relates to a technical field of analog simulation, and more particularly to a finite element interpolation function construction method and a system thereof.

### Description of Related Arts

Conventionally, the finite element is an essential important part of engineering analysis and design, and the finite element calculation software has been widely applied in every field of structure, solid and fluid analysis engineering. Actually, the finite element is almost applied in every field of engineering analysis.

After determining the mathematical model (such as the basic variable, the basic equation, the solution domain and the boundary condition) of the engineering or physical problem, the finite element as the numerical calculation method for analyzing the mathematical model can be summarized into following three parts.

(1) A solution domain representing the structure or the non-individual body is discretized into several subdomains (elements), and through the nodes thereof on the boundary, the subdomains are connected with each other and form the combination. The above-mentioned is the pre-processing part of the finite element software, namely the element dividing part, and the technology thereof is mature.

(2) The unknown variables in the full solution domain are represented by the assumed approximate function in each element. The approximate function in each element is represented by the values of the unknown filed function and the derivative thereof on each node of the element and the corresponding interpolation function. The above-mentioned is the formation part of the finite element interpolation function in the finite element software. The difficulty for constructing the finite element interpolation function is high that many problems exist, and it is still unable to construct the finite element interpolation function meeting the basic convergence requirements, which is always the difficult problem in the finite element research field.

The construction results of the finite element interpolation functions for the same problem are not only one. The selection of the finite element interpolation function has the great effect on the calculation analysis accuracy of the finite element software and is directly related to the success or failure of the calculation result of the finite element software. For the construction of the high-accuracy finite element interpolation function, three key conditions exist. Firstly, the higher the completeness order of the polynomial used by the finite element interpolation function, the higher calculation accuracy. Secondary, the displacement (including the displacement derivative) of the finite element interpolation function on the common boundary of the adjacent element is required to be compatible, namely the displacement is required to be consistent with that of the adjacent element at the same common boundary; otherwise, the displacement conflict will cause the energy lose and decrease the calculation accuracy. Thirdly, the finite element interpolation function is required to be suitable for the curved-surface (curvilinear) boundary. So far, it is still unable to construct the finite element interpolation function meeting all the above conditions, and it is greatly difficult to construct the high-order complete compatible finite element interpolation function.

The conventional construction of the interpolation function generally adopts the isoparametric coordinate method. However, no matter the planar solid element, the three-dimensional solid element, the planar thin-plate element and the spatial shell element, the problems of the low calculation accuracy, the limited application range, the incompatibility and/or the unsuitability for the curvilinear boundary still exist. Examples are described as follows.

1) Four-node quadrilateral element which is constructed based on the isoparametric coordinate method

The element merely has the first-order complete compatibility, is only able to meet the basic convergence requirements of the finite element calculation, and has the low calculation accuracy.

2) Eight-node curved quadrilateral element which is constructed based on the isoparametric coordinate method

The element has the doubled node number. However, the element also merely has the first-order complete compatibility, is only able to meet the basic convergence requirements of the finite element calculation, and has the low calculation accuracy.

When the element is rectangular, the element has the second-order complete compatibility; however, at the moment, the element is not suitable for the curvilinear boundary and has the limited application range.

3) Twelve-node curved quadrilateral element which is constructed based on the isoparametric coordinate method

The element interpolation function merely has the second-order complete compatibility and has the low calculation accuracy. When the element is rectangular, the element interpolation function has the third-order complete compatibility; however, at the moment, the element is not suitable for the curvilinear boundary and has the limited application range.

4) Eight-node hexahedral element which is constructed based on the isoparametric coordinate method

When the element is the hexahedral element, the interpolation function is suitable for the broken-line boundary. However, the element interpolation function merely has the first-order completeness, is only able to meet the basic convergence requirements of the finite element calculation, and has the low calculation accuracy.

When the element is cuboid, the element interpolation function has the second-order complete compatibility; however, at the moment, the interpolation function is not suitable for the broken-line boundary and has the limited application range.

5) Twenty-node curved-surface hexahedral element which is constructed based on the isoparametric coordinate method

No matter the element is hexahedral or cuboid, the finite element interpolation function merely has the second-order complete compatibility and has the limited calculation accuracy.

6) Thirty-two-node curved-surface hexahedral element which is constructed based on the isoparametric coordinate method

No matter the element is hexahedral or cuboid, the finite element interpolation function merely has the second-order complete compatibility and has the low calculation accuracy.

7) Four-node (relating to the node parameters of w,θₓ,θ_{y},θ_{xy}) third-order complete rectangular thin-plate element displacement interpolation function which is constructed based on the isoparametric coordinate method

Although the element displacement interpolation function has the relatively high completeness order, the normal corner displacement at the boundary of the element is incompatible, and the interpolation function is not suitable for the broken-line boundary and has the limited application range.

8) Based on the isoparametric coordinate method, it is still unable to construct the second-order complete four-node quadrilateral thin-plate element and solve the element compatibility problem.

9) Based on the isoparametric coordinate method, merely the displacement interpolation functions of the planar four-node incompatible rectangular and triangular thin-plate element are able to be applied in the spatial thin-shell structure through the coordinate transformation method. However, the interpolation function has the limited application range and is incompatible.

10) Displacement interpolation function of the three-dimensional eight-node compatible low-order complete quadrilateral hyper-parameter curved-surface shell element and displacement interpolation function of the three-dimensional eight-node low-order complete compatible curved-surface quadrilateral relative-freedom shell element which are constructed based on the isoparametric coordinate method

The above two element displacement interpolation functions are compatible and suitable for both the thick-shell and thin-shell structure. However, the interpolation functions merely have the first-order completeness and have the low calculation accuracy. When the thickness of the shell tends to the thin-shell, the problems of shear-locking and film-locking exist.

In conclusion, the conventional finite element software constructs the element interpolation function for solving the physical quantities (such as displacement, temperature, fluid and electromagnetism) based on the single isoparametric coordinate method (or the areal coordinate system). The constructed element interpolation function does not have the high-order completeness and compatibility. Even though the interpolation function is complete, the interpolation function only has the low-order completeness and has the low calculation accuracy. For the structural problem, the finite element interpolation function, which not only meets the finite element basic convergence requirements but also has the high-order completeness and compatibility, is still not constructed.

### SUMMARY OF THE PRESENT INVENTION

An object of the present invention is to provide a method for constructing a finite element interpolation function, so as to improve performance of the interpolation function.

In order to accomplish the above object, the present invention provides a method for constructing a finite element interpolation function, comprising steps of: constructing an interpolation function through a hybrid coordinate system formed by a linear transformation coordinate system and an isoparametric coordinate system; and

according to characteristics of a target solid element, determining a coordinate variable number, a term number and an order of the interpolation function, wherein: the characteristics of the target solid element comprise a known node number and a known node displacement component number; the term number of the constructed interpolation function is equal to a total displacement number of related interpolation nodes of the target solid element; meanwhile, a part corresponding to the linear transformation coordinate system in the constructed interpolation function is a highest-order complete polynomial with orders of every term progressively increasing from low to high after covering every coordinate variable combination; and, in a highest order of the part corresponding to the linear transformation coordinate system, orders of every term of a part corresponding to the isoparametric coordinate system in the constructed interpolation function increase progressively from low to high after covering every coordinate variable combination and are distributed symmetrically.

According to the present invention, the constructed interpolation function preferably comprises at least one of following items.

1) When the target solid element is a two-dimensional eight-node high-order complete compatible quadrilateral curved element, the constructed element displacement interpolation function is that:

u(v)=a₁+a₂T₁+a₃T₂+a₄T₁²+a₅T₁T₂+a₆T₂²+a₇ξ²η+a₈ξη².

2) When the target solid element is a two-dimensional twelve-node high-order complete compatible quadrilateral curved element, the constructed element displacement interpolation function is that:

u(v)=a₁+a₂T₁+a₃T₃+a₄T₁²+a₅T₁T₂+a₆T₂²+a₇T₁³+a₈T₂¹T₂+a₉T₁T₂²+a₁₀T₂³+a₁₁ξ³η+a₁₂ξη³.

3) When the target solid element is a three-dimensional twenty-node high-order complete compatible curved-surface hexahedral element, the constructed element displacement interpolation function is that:

u(v,w)=a₁+a₂T₁+a₃T₂+a₄T₃+a₅T₁²+a₆T₂²+a₇T₃²+a₈T₁T₂+a₉T₁T₂+a₁₀T₂T₃+a₁₁ξ²ηζ+a₁₂ξ²ζ+a₁₃ξη²+a₁₄η²ζ+a₁₅ξζ²+a₁₆ηζ²+a₁₇ξηζ+a₁₈ξ²ηζ+a₁₉ξη²ζ+a₂₀ξηζ².

4) When the target solid element is a three-dimensional thirty-two-node high-order complete compatible curved-surface hexahedral element, the constructed element displacement interpolation function is that:

u(v,w)=a₁+a₂T₁+a₃T₂+a₄T₃+a₅T₁²+a₆T₂²+a₇T₃²+a₈T₁T₂+a₉T₁T₃a+a₁₀T₂T₃a₁₁T₁³+a₁₂T₂³+a₁₃T₃³+a₁₄T₁²T₂+a₁₅T₁²T₃+a₁₆T₁T₂²+a₁₇T₂²T₃+a₁₈T₁T₃²+a₁₉T₂T₃²+a₂₀T₁T₂T₃+a₂₁ξ³ηζ+a₂₂ξ³ζ+a₂₃ξη³+a₂₄η³ζ+a₂₅ξζ³+a₂₆ηζ³+a₂₇ξ²ηζ+a₂₈ξη²ζ+a₂₉ξηζ²+a₃₀ξ²η²+a₃₁ξ²ζ²+a₃₂η²ζ²

5) When the target solid element is a two-dimensional four-node high-order complete compatible quadrilateral thin-plate element with every node having three related displacement components of w,θₓ,θ_{y}, the constructed element displacement interpolation function is that:

w=a₁+a₂T₁+a₃T₂+a₄T₁²+a₅T₁T₂+a₆T₂²+a₇T₁³+a₈T₁²T₂+a₉T₁T₂²+a₁₀T₂³+a₁₁ξ³η+a₁₂ξη³.

6) When the target solid element is a two-dimensional eight-node high-order complete compatible curved quadrilateral thin-plate element with every node having three related displacement components of w,θₓ,θ_{y}, the constructed element displacement interpolation function is that:

w=a₁+a₂T₁+a₃T₂+a₄T₁²+a₅T₁T₂+a₆T₂²+a₇T₁³+a₈T₁²T₂+a₉T₁T₂²+a₁₀T₂³+a₁₁T₁⁴+a₁₂T₁³T₂+a₁₃T₁²T₂²+a₁₄T₁T₂³+a₁₅T₂⁴+a₁₆T₁⁵+a₁₇T₁⁴T₂+a₁₈T₁³T₂²+a₁₉T₁²T₂³+a₂₀T₁T₂⁴+a₂₁T₂⁵+a₂₂ξ⁴η²+a₂₃ξ³η³+a₂₄ξ²η⁴

7) When the target solid element is a three-dimensional four-node high-order complete compatible quadrilateral flat-plate thin-shell element (relating to w,θₓ,θ_{y}), the constructed element displacement interpolation function is that:

$$\{ \begin{matrix}u ( v ) = {a}_{1} + {a}_{2} {T}_{1} + {a}_{3} {T}_{2} + {a}_{4} ξ η \\ w = \begin{matrix}{a}_{1} + {a}_{2} {T}_{1} + {a}_{3} {T}_{2} + {a}_{4} {T}_{1}^{2} + {a}_{5} {T}_{1} {T}_{2} + \\ {a}_{6} {T}_{2}^{2} + {a}_{7} {T}_{1}^{3} + {a}_{8} {T}_{1}^{2} {T}_{2} + {a}_{9} {T}_{1} {T}_{2}^{2} + \\ {a}_{10} {T}_{2}^{3} + {a}_{11} {ξ}^{3} η + {a}_{12} ξ {η}^{3}\end{matrix}\end{matrix} .$$

8) When the target solid element is a three-dimensional eight-node high-order complete compatible curvilinear quadrilateral flat-plate thin-shell element (relating to w,θₓ,θ_{y}), the constructed element displacement interpolation function is that:

$$\{ \begin{matrix}u ( v ) = {a}_{1} + {a}_{2} {T}_{1} + {a}_{3} {T}_{2} + {a}_{4} {T}^{2} + {a}_{5} {T}_{1} {T}_{2} + {a}_{6} {T}_{2}^{2} + {a}_{7} {ξ}^{2} η + {a}_{8} ξ {η}^{2} \\ w = \begin{matrix}{a}_{1} + {a}_{2} {T}_{1} + {a}_{3} {T}_{2} + {a}_{4} {T}_{1}^{2} + {a}_{5} {T}_{1} {T}_{2} + \\ {a}_{6} {T}_{2}^{2} + {a}_{7} {T}_{1}^{3} + {a}_{8} {T}_{1}^{2} {T}_{2} + {a}_{9} {T}_{1} {T}_{2}^{2} + {a}_{10} {T}_{2}^{3} + \\ {a}_{11} {T}_{1}^{4} + {a}_{12} {T}_{1}^{3} {T}_{2} + {a}_{13} {T}_{1}^{2} {T}_{2}^{2} + {a}_{14} {T}_{1} {T}_{2}^{3} + {a}_{15} {T}_{2}^{4} + \\ {a}_{16} {T}_{1}^{5} + {a}_{17} {T}_{1}^{4} {T}_{2} + {a}_{18} {T}_{1}^{3} {T}_{2}^{2} + {a}_{19} {T}_{1}^{2} {T}_{2}^{3} + \\ {a}_{20} {T}_{1} {T}_{2}^{4} + {a}_{21} {T}_{2}^{5} + {a}_{22} {ξ}^{4} {η}^{2} + {a}_{23} {ξ}^{3} {η}^{3} + {a}_{24} {ξ}^{2} {η}^{4}\end{matrix} .\end{matrix}$$

In above equations, T₁, T₂ and T₃ are respectively coordinate axes of the linear transformation coordinate system in an element curved-surface; ξ, η and ζ are respectively coordinate axes of the isoparametric coordinate system; u, v and w respectively correspond to displacements on three local coordinate directions in the element curved-surface; θₓ and θ_{y} are partial derivatives of w respectively with respect to x and Y in the element curved-surface, and θ_{xy} is a second-order cross partial derivative of w with respect to x and y.

According to the present invention, for the conventional spatial thin-shell adopted in engineering, the suitable orthogonal curvilinear coordinates and the corresponding geometric equation are adopted. According to the above-described principle, as the planar problem, the high-order complete compatible curved-surface thin-shell element is directly constructed in the spatial orthogonal curvilinear coordinate system; then the element stiffness matrix is calculated, and the spatial coordinate transformation is implemented. Detailed conditions are described as follows.

9) When the target solid element is a three-dimensional four-node high-order complete compatible quadrilateral curved-surface thin-shell element (relating to w,θₓ,θ_{y}), the constructed element displacement interpolation function is that:

$$\{ \begin{matrix}u ( v ) = {a}_{1} + {a}_{2} {T}_{1} + {a}_{3} {T}_{2} + {a}_{4} ξ η \\ w = \begin{matrix}{a}_{1} + {a}_{2} {T}_{1} + {a}_{3} {T}_{2} + {a}_{4} {T}_{1}^{2} + {a}_{5} {T}_{1} {T}_{2} + {a}_{6} {T}_{2}^{2} + \\ {a}_{7} {T}_{1}^{3} + {a}_{8} {T}_{1}^{2} {T}_{2} + {a}_{9} {T}_{1} {T}_{2}^{2} + {a}_{10} {T}_{2}^{3} + {a}_{11} {ξ}^{3} η + {a}_{12} ξ {η}^{3}\end{matrix} .\end{matrix}$$

10) When the target solid element is a three-dimensional eight-node high-order complete compatible quadrilateral curved-surface thin-shell element (relating to w,θₓ,θ_{y}), the constructed element displacement interpolation function is that:

$$\{ \begin{matrix}u ( v ) = {a}_{1} + {a}_{2} {T}_{1} + {a}_{3} {T}_{2} + {a}_{4} {T}^{2} + {a}_{5} {T}_{1} {T}_{2} + {a}_{6} {T}_{2}^{2} + {a}_{7} {ξ}^{2} η + {a}_{8} ξ {η}^{2} \\ w = \begin{matrix}{a}_{1} + {a}_{2} {T}_{1} + {a}_{3} {T}_{2} + {a}_{4} {T}_{1}^{2} + {a}_{5} {T}_{1} {T}_{2} + \\ {a}_{6} {T}_{2}^{2} + {a}_{7} {T}_{1}^{3} + {a}_{8} {T}_{1}^{2} {T}_{2} + {a}_{9} {T}_{1} {T}_{2}^{2} + {a}_{10} {T}_{2}^{3} + \\ {a}_{11} {T}_{1}^{4} + {a}_{12} {T}_{1}^{3} {T}_{2} + {a}_{13} {T}_{1}^{2} {T}_{2}^{2} + {a}_{14} {T}_{1} {T}_{2}^{3} + {a}_{15} {T}_{2}^{4} + \\ {a}_{16} {T}_{1}^{5} + {a}_{17} {T}_{1}^{4} {T}_{2} + {a}_{18} {T}_{1}^{3} {T}_{2}^{2} + {a}_{19} {T}_{1}^{2} {T}_{2}^{3} + {a}_{20} {T}_{1} {T}_{2}^{4} + \\ {a}_{21} {T}_{2}^{5} + {a}_{22} {ξ}^{4} {η}^{2} + {a}_{23} {ξ}^{3} {η}^{3} + {a}_{24} {ξ}^{2} {η}^{4}\end{matrix} .\end{matrix}$$

In above equations, T₁, T₂, and T₃ are respectively the coordinate axes of the linear transformation coordinate system in the element curved-surface; ξ, η and ζ are respectively the coordinate axes of the isoparametric coordinate system; u, v and w respectively correspond to the displacements on three local coordinate directions in the element curved-surface; θₓ and θ_{y} are the partial derivatives of w respectively with respect to x and Y in the element curved-surface, and θ_{xy} is the second-order cross partial derivative of w with respect to x and y.

Preferably, for the shell element on the curvilinear coordinate system, the complete rigid-body displacement is supplemented in the displacement mode.

Further preferably, when the target solid element is a two-dimensional four-node high-order complete compatible quadrilateral thin-plate element, a two-dimensional eight-node high-order complete compatible curved quadrilateral thin-plate element, a three-dimensional four-node high-order complete compatible quadrilateral flat-plate thin-shell element, a three-dimensional eight-order high-order complete compatible curved quadrilateral flat-plate thin-shell element, a three-dimensional four-node high-order complete compatible quadrilateral curved-surface thin-shell element or a three-dimensional eight-node high-order complete compatible quadrilateral curved-surface thin-shell element, the incompatible normal corner displacement at the boundary of the element is modified through the following equation of:

$$Δ w = - \frac{( 1 - {η}^{2} ) ( 1 + ξ ) {( 1 - ξ )}^{2}}{4 ( 2 + ξ + η ) ( 2 + ξ - η )} Δ {θ}_{η 23} ( η ) + \frac{( 1 - {η}^{2} ) ( 1 - ξ ) {( 1 + ξ )}^{2}}{4 ( 2 - ξ + η ) ( 2 - ξ - η )} Δ {θ}_{η 14} + \frac{( 1 - {ξ}^{2} ) ( 1 + η ) {( 1 - η )}^{2}}{4 ( 2 + ξ + η ) ( 2 - ξ + η )} Δ {θ}_{η 34} ( ξ ) - \frac{( 1 - {ξ}^{2} ) ( 1 - η ) {( 1 + η )}^{2}}{4 ( 2 + ξ - η ) ( 2 - ξ - η )} Δ {θ}_{ξ 12} ( ξ ) ; \\$$

wherein Δθ_{η23}(η), Δθ_{η14}(η), Δθ_{ξ34}(ξ) and Δθ_{ξ12}(ξ) are the incompatible normal corner displacements of four boundaries of the element, which are zero at the node.

Preferably, according to the present invention, the transformation equation between the global coordinate system and the linear transformation coordinate system has following conditions.

In the two-dimensional condition,

$$\{ \begin{matrix}{T}_{1} = {o}_{1} x + {b}_{1} y + {c}_{1} \\ {T}_{2} = {o}_{2} x + {b}_{2} y + {c}_{2}\end{matrix} ;$$

six undetermined coefficients oᵢ,bᵢ,cᵢ(i=1,2) exist in the coordinate transformation relation, which are determined by the equation set having six linear transformation coordinate values of 0 or 1.

In the three-dimensional condition,

$$\{ \begin{matrix}{T}_{1} = {o}_{1} x + {b}_{1} y + {c}_{1} z + {d}_{1} \\ {T}_{2} = {o}_{2} x + {b}_{2} y + {c}_{2} z + {d}_{2} \\ {T}_{3} = {o}_{3} x + {b}_{3} y + {c}_{3} z + {d}_{3}\end{matrix} ;$$

twelve undetermined coefficients oᵢ,bᵢ,cᵢ,dᵢ(i=1,2,3) exist in the coordinate transformation relation, which are determined by the equation set having twelve linear coordinate values of 0 or 1.

Preferably, according to the present invention, the transformation equation between the global coordinate system and the isoparametric coordinate system is that:

$$\{ \begin{matrix}x \\ y \\ z\end{matrix} \} = {\sum }_{i = 1}^{n} {N}_{i} ( ξ ) [ \begin{matrix}{x}_{i} \\ {y}_{i} \\ {z}_{i}\end{matrix} ] .$$

Based on the above constructed interpolation function, through the variation principle or the weight residual method equivalent to the mathematic model (the basic equation and boundary conditions) of the original problem, the finite element establishes the algebraic equation set or the ordinary differential equation set for solving the basic unknown quantities (node values of the field function), and then the problem solution is obtained after solving the equation set. The above-described is namely the assembling and solving of the algebraic equation set or the ordinary differential equation set, and the technology thereof is mature and has the standard solving module.

In conclusion, the present invention has following beneficial effects.

Based on the hybrid coordinate system formed by the linear transformation coordinate system and the isoparametric coordinate system, not based on the single coordinate system, the interpolation function for solving physical quantities is constructed, which enables the calculation accuracy of the finite element analysis software to be greatly increased, improves the safety reliability of the structural design and optimizes the structural design; the constructed interpolation function becomes more suitable for various curved-surface (curvilinear) boundary, thereby bringing great economic benefit to the construction of engineering, aviation and aerospace.

The present invention is further illustrated in detail with following accompanying drawings.

### BRIEF DESCRIPTION OF THE DRAWINGS

The accompanying drawings are for providing a further understanding of the present invention. The preferred embodiment and the illustration thereof are for illustrating the present invention, not for improperly limiting the present invention.

FIG. 1 is a flow chart of a method for constructing a finite element interpolation function according to a preferred embodiment of the present invention.

FIG. 2 (a) is a sketch view of a global coordinate system in a planar linear transformation coordinate system according to the preferred embodiment of the present invention.

FIG. 2 (b) is a sketch view of linear transformation coordinates in the planar linear transformation coordinate system according to the preferred embodiment of the present invention.

FIG. 3 (a) is a sketch view of a global coordinate system in a spatial linear transformation coordinate system according to the preferred embodiment of the present invention.

FIG. 3 (b) is a sketch view of linear transformation coordinates in the spatial linear transformation coordinate system according to the preferred embodiment of the present invention.

FIG. 4 (a) is a sketch view of a global coordinate system of an eight-node quadrilateral curved element according to the preferred embodiment of the present invention.

FIG. 4(b) is a sketch view of an isoparametric coordinate system of the eight-node quadrilateral curved element according to the preferred embodiment of the present invention.

FIG. 4(c) is a sketch view of a linear transformation coordinate system of the eight-node quadrilateral curved element according to the preferred embodiment of the present invention.

FIG. 5(a) is a sketch view of a global coordinate system of a twelve-node quadrilateral curved element according to the preferred embodiment of the present invention.

FIG. 5(b) is a sketch view of an isoparametric coordinate system of the twelve-node quadrilateral curved element according to the preferred embodiment of the present invention.

FIG. 5(c) is a sketch view of a linear transformation coordinate system of the twelve-node quadrilateral curved element according to the preferred embodiment of the present invention.

FIG. 6(a) is a sketch view of a global coordinate system of a twenty-node curved-surface hexahedral element according to the preferred embodiment of the present invention.

FIG. 6(b) is a sketch view of an isoparametric coordinate system of the twenty-node curved-surface hexahedral element according to the preferred embodiment of the present invention.

FIG. 6(c) is a sketch view of a linear transformation coordinate system of the twenty-node curved-surface hexahedral element according to the preferred embodiment of the present invention.

FIG. 7(a) is a sketch view of a global coordinate system of a thirty-two-node curved-surface hexahedral element according to the preferred embodiment of the present invention.

FIG. 7(b) is a sketch view of an isoparametric coordinate system of the thirty-two-node curved-surface hexahedral element according to the preferred embodiment of the present invention.

FIG. 7(c) is a sketch view of a linear transformation coordinate system of the thirty-two-node curved-surface hexahedral element according to the preferred embodiment of the present invention.

FIG. 8(a) is a sketch view of a global coordinate system of a four-node quadrilateral thin-plate element according to the preferred embodiment of the present invention.

FIG. 8(b) is a sketch view of an isoparametric coordinate system of the four-node quadrilateral thin-plate element according to the preferred embodiment of the present invention.

FIG. 8(c) is a sketch view of a linear transformation coordinate system of the four-node quadrilateral thin-plate element according to the preferred embodiment of the present invention.

FIG. 9(a) is a sketch view of a global coordinate system of an eight-node curved quadrilateral thin-plate element according to the preferred embodiment of the present invention.

FIG. 9(b) is a sketch view of an isoparametric coordinate system of the eight-node curved quadrilateral thin-plate element according to the preferred embodiment of the present invention.

FIG. 9(c) is a sketch view of a linear transformation coordinate system of the eight-node curved quadrilateral thin-plate element according to the preferred embodiment of the present invention.

FIG. 10(a) is a sketch view of a global coordinate system of a spatial four-node quadrilateral thin-shell element according to the preferred embodiment of the present invention.

FIG. 10(b) is a sketch view of an isoparametric coordinate system of the spatial four-node quadrilateral thin-shell element according to the preferred embodiment of the present invention.

FIG. 10(c) is a sketch view of a linear transformation coordinate system of the spatial four-node quadrilateral thin-shell element according to the preferred embodiment of the present invention.

FIG. 11(a) is a sketch view of a global coordinate system of a spatial eight-node quadrilateral thin-shell element according to the preferred embodiment of the present invention.

FIG. 11(b) is a sketch view of an isoparametric coordinate system of the spatial eight-node quadrilateral thin-shell element according to the preferred embodiment of the present invention.

FIG. 11(c) is a sketch view of a linear transformation coordinate system of the spatial eight-node quadrilateral thin-shell element according to the preferred embodiment of the present invention.

FIG. 12(a) is a sketch view of a global coordinate system of a spatial four-node quadrilateral curved-surface thin-shell element according to the preferred embodiment of the present invention.

FIG. 12(b) is a sketch view of an isoparametric coordinate system of the spatial four-node quadrilateral curved-surface thin-shell element according to the preferred embodiment of the present invention.

FIG. 12(c) is a sketch view of a linear transformation coordinate system of the spatial four-node quadrilateral curved-surface thin-shell element according to the preferred embodiment of the present invention.

FIG. 13(a) is a sketch view of a global coordinate system of a spatial eight-node quadrilateral curved-surface thin-shell element according to the preferred embodiment of the present invention.

FIG. 13(b) is a sketch view of an isoparametric coordinate system of the spatial eight-node quadrilateral curved-surface thin-shell element according to the preferred embodiment of the present invention.

FIG. 13(c) is a sketch view of a linear transformation coordinate system of the spatial eight-node quadrilateral curved-surface thin-shell element according to the preferred embodiment of the present invention.

### DETAILED DESCRIPTION OF THE PREFERRED EMBODIMENT

The preferred embodiment of the present invention is further described in detail with the accompanying drawings, but the present invention can be implemented in various ways limited and covered by the claims.

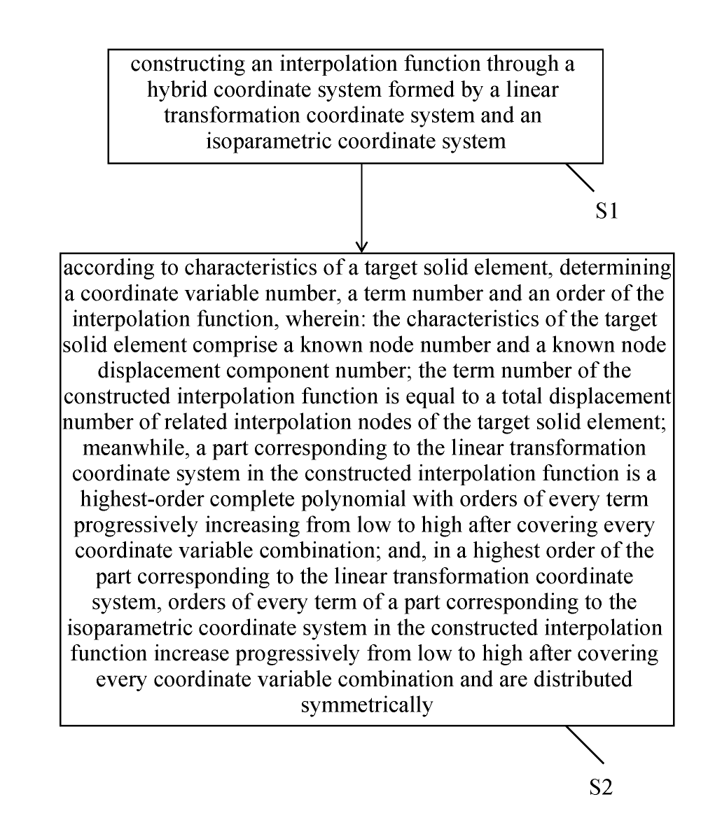

As shown in FIG. 1, according to the preferred embodiment of the present invention, a method for constructing a finite element interpolation function comprises steps of:

S1, constructing an interpolation function through a hybrid coordinate system formed by a linear transformation coordinate system and an isoparametric coordinate system; wherein:

the linear transformation coordinate system namely a birectangular coordinate system has a linear transformation relation; the isoparametric coordinate system is a nonlinear transformation coordinate system; a conventional orthogonal curved-surface transformation coordinate system on a curved-surface thin-shell element corresponds to a global coordinate system of a general structural element and can be also transformed into the linear transformation coordinate system;

the linear transformation coordinate system has following contributions that: (1), through the linear transformation coordinate system, an element can be transformed into a shape element having a right-angle face (line), so that part of node coordinate values of the element can be transformed into 0 and 1, thereby decreasing a construction difficulty and increasing a calculation accuracy of the finite element interpolation function; and (2), through the linear transformation coordinate system, a complete order of a polynomial after coordinate transformation does not increase that the complete order of the polynomial of the finite element interpolation function in the transformed coordinate system is equal to that in the global coordinate system, so that construction of a high-order complete finite element interpolation function becomes possible;

the linear transformation coordinate system can be divided into a planar linear transformation coordinate system and a spatial linear transformation coordinate system;

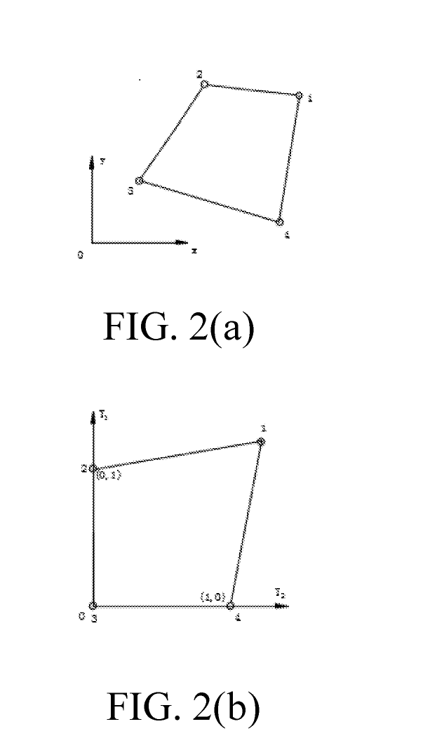

(a) for the planar linear transformation coordinate system, a coordinate transformation relation is assumed to be:

$$\{ \begin{matrix}{T}_{1} = {o}_{1} x + {b}_{1} y + {c}_{1} \\ {T}_{2} = {o}_{2} x + {b}_{2} y + {c}_{2}\end{matrix} ;$$

wherein: shapes of the element after the coordinate transformation are showed in FIG. 2(a) and FIG. 2(b); one angular point of the quadrilateral element is located at an original point of the coordinate system, and two angular points of the quadrilateral element are located on coordinate axes; and six undetermined coefficients oᵢ,bᵢ,cᵢ(i=1,2) exist in the coordinate transformation relation, which can be transformed into six linear transformation coordinate values of 0 or 1;

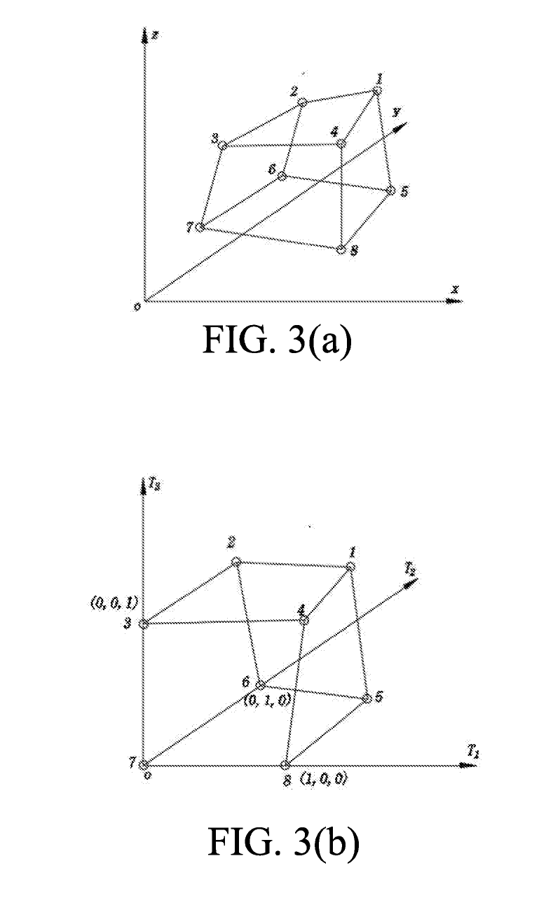

(b) for the spatial linear transformation coordinate system, a coordinate transformation relation is assumed to be:

$$\{ \begin{matrix}{T}_{1} = {o}_{1} x + {b}_{1} y + {c}_{1} z + {d}_{1} \\ {T}_{2} = {o}_{2} x + {b}_{2} y + {c}_{2} z + {d}_{2} \\ {T}_{3} = {o}_{3} x + {b}_{3} y + {c}_{3} z + {d}_{3}\end{matrix} ;$$

wherein: shapes of the element after the coordinate transformation are showed in FIG. 3(a) and FIG. 3(b); one angular point of the hexahedral element is located at the original point of the coordinate system, and three angular points of the hexahedral element are located on coordinate axes; and twelve undetermined coefficients oᵢ,bᵢ,cᵢ, dᵢ(i=1,2,3) exist in the coordinate transformation relation, which can be transformed into twelve linear transformation coordinate values of 0 or 1; and

in the step of S1, a transformation equation between the global coordinate system and the isoparametric coordinate system is that:

$$\{ \begin{matrix}x \\ y \\ z\end{matrix} \} = {\sum }_{i = 1}^{n} {N}_{i} ( ξ ) [ \begin{matrix}{x}_{i} \\ {y}_{i} \\ {z}_{i}\end{matrix} ] ;$$

S2, according to characteristics of a target solid element, determining a coordinate variable number, a term number and an order of the interpolation function, wherein: the characteristics of the target solid element comprise a known node number and a known node displacement component number; the term number of the constructed interpolation function is equal to a total displacement number of related interpolation nodes of the target solid element; meanwhile, a part corresponding to the linear transformation coordinate system in the constructed interpolation function is a highest-order complete polynomial with orders of every term progressively increasing from low to high after covering every coordinate variable combination; and, in a highest order of the part corresponding to the linear transformation coordinate system, orders of every term of a part corresponding to the isoparametric coordinate system in the constructed interpolation function increase progressively from low to high after covering every coordinate variable combination and are distributed symmetrically.

In particular cases, if a total term number corresponding to the linear transformation coordinate system is equal to the total term number of the constructed interpolation function, the isoparametric coordinate system will not appear in the constructed interpolation function.

According to the preferred embodiment, through the above steps, the finite element interpolation function is constructed based on the hybrid coordinate system formed by the linear transformation coordinate system combined with the isoparametric coordinate system. In a choice of the finite element interpolation polynomial, a complete term of the finite element interpolation polynomial uses the linear transformation coordinates, while a superfluous term uses the isoparametric coordinates. Through representing the linear transformation coordinates by the isoparametric coordinates and then substituting into the finite element interpolation polynomial, an polynomial order represented by the isoparametric coordinates is not higher than the complete order of the finite element interpolation polynomial, so as to guarantee that the finite element interpolation function has C⁰-order compatibility on an element boundary; otherwise, if the non-complete term exists in the finite element interpolation polynomial and is not replaced by the isoparametric coordinates, the C⁰-order compatibility of the finite element interpolation function on the element boundary cannot be guaranteed. Therefore, the problem of incompatibility caused by the high-order complete finite element interpolation function is cleverly solved.

Functions constructed for different target solid elements are described as follows.

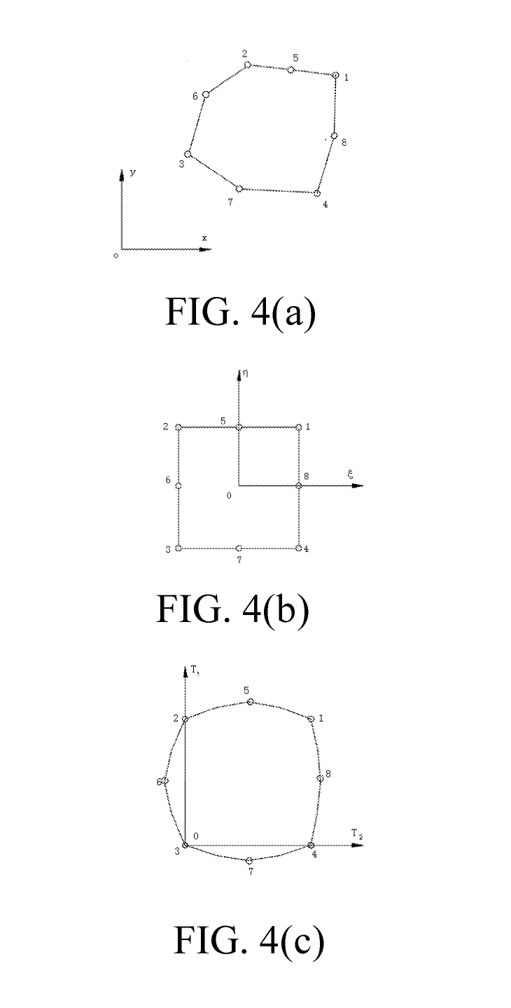

1) As shown in FIG. 4(a), FIG. 4(b) and FIG. 4(c), when the target solid element is a two-dimensional eight-node high-order complete compatible quadrilateral curved element, the constructed element displacement interpolation function is that:

u(v)=a₁+a₂T₁+a₃T₂+a₄T₁²+a₅T₁T₂+a₆T₂²+a₇ξ²η+a₈ξη².

In following equations, T₁, T₂ and T₃ are respectively coordinate axes of the linear transformation coordinate system in an element curved-surface; ξ, η and ζ are respectively coordinate axes of the isoparametric coordinate system; u, v and w respectively correspond to displacements on three local coordinate directions in the element curved-surface; θₓ and θ_{y} are partial derivatives of w respectively with respect to x and Y in the element curved-surface, and θ_{xy} is a second-order cross partial derivative of w with respect to x and y; moreover, in following conditions, a total displacement number of the related interpolation nodes corresponding to u(v) and u(v,w) is equal to the known node number, and a total displacement number of the related interpolation nodes corresponding to w is equal to product of the known node number and the related displacement component; the above will not be repeated in the following description.

For the element displacement interpolation function, an equation set is established according to the element node displacements, and undetermined coefficients a₁-a₈ are determined through simultaneous solution. Because the constructed interpolation function has the second-order completeness, the eight-node quadrilateral element can only have the second-order completeness, which is higher than the completeness of the conventional element displacement interpolation function by one order. Once the completeness of the element displacement interpolation function is increased by one order, the convergence performance and the anti-distortion performance thereof will greatly increase.

When a common boundary of two adjacent elements is a straight line and nodes in the boundary equally divide the boundary, the boundary is compatible, which is irrelevant to other boundary shapes of the elements. Thus, when element dividing, it is merely required that the common boundary of two adjacent elements is kept to be a straight line and the nodes in the boundary equally divide the boundary, without any compatibility requirement on free outer boundary of the element that the free outer boundary can be a curve; and at the moment, the displacement interpolation function of the two-dimensional eight-node element has the high-order complete compatibility and is suitable for the curvilinear boundary, and the difficulty of element dividing is not increased. The two-dimensional eight-node quadrilateral curved element can degenerate into a six-node triangular curved element.

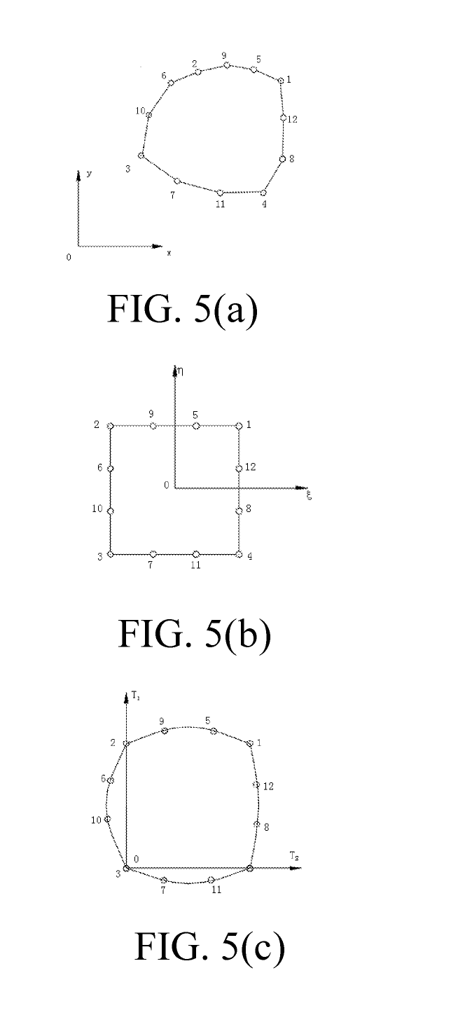

2) As shown in FIG. 5(a), FIG. 5(b) and FIG. 5(c), when the target solid element is a two-dimensional twelve-node high-order complete compatible quadrilateral curved element, the constructed element displacement interpolation function is that:

u(v)=a₁+a₂T₁+a₃T₂+a₄T₁²+a₅T₁T₂+a₆T₂²+a₇T₁³+a₈T₁²T₂+a₉T₁T₂²+a₁₀T₂³+a₁₁ξ³η+a₁₂ξη³.

For the element displacement interpolation function, an equation set is established according to the element node displacements, and undetermined coefficients a₁-a₁₂ are determined through the simultaneous solution. The constructed interpolation function has the third-order completeness, which is higher than the completeness of the conventional element displacement interpolation function by two orders, so that the constructed interpolation function will have the great convergence performance and anti-distortion performance. When a common boundary of two adjacent elements is a straight line and nodes in the boundary equally divide the boundary, the boundary is compatible, which is irrelevant to other boundary shapes of the elements. Thus, when element dividing, it is merely required that the common boundary of two adjacent elements is kept to be a straight line and the nodes in the boundary equally divide the boundary, without any compatibility requirement on free outer boundary of the elements that the free outer boundary can be a curve; and at the moment, the displacement interpolation function of the two-dimensional twelve-node element has the high-order complete compatibility and is suitable for any curvilinear boundary, and the difficulty of element dividing is not increased. The two-dimensional twelve-node quadrilateral curved element can degenerate into a nine-node triangular curved element.

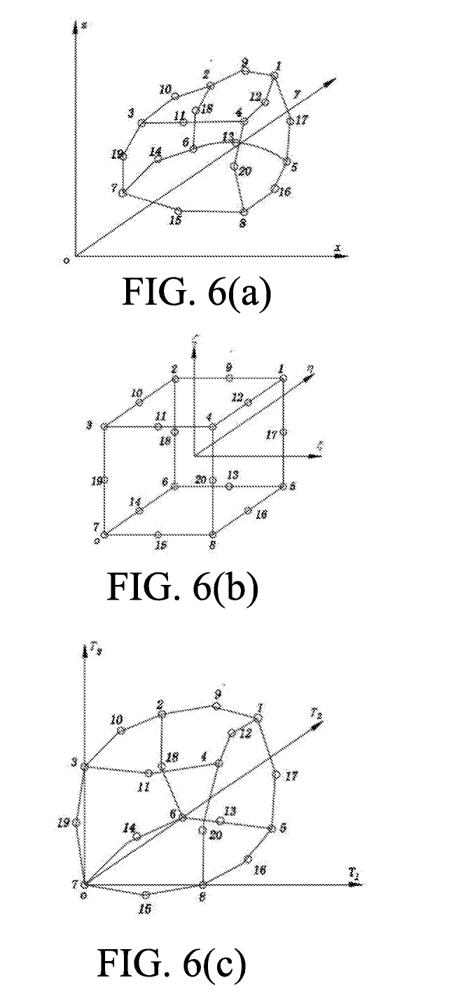

3) As shown in FIG. 6(a), FIG. 6(b) and FIG. 6(c), when the target solid element is a three-dimensional twenty-node high-order complete compatible curved-surface hexahedral element, the constructed element displacement interpolation function is that:

u(v,w)=a₁+a₂T₁+a₃T₂+a₄T₃+a₅T₁²+a₆T₂²+a₇T₃²+a₈T₁T₂+a₉T₁T₂+a₁₀T₂T₃+a₁₁ξ²ηζ+a₁₂ξ²ζ+a₁₃ξη²+a₁₄η²ζ+a₁₅ξζ²+a₁₆ηζ²+a₁₇ξηζ+a₁₈ξ²ηζ+a₁₉ξη²ζ+a₂₀ξηζ².

For the element displacement interpolation function, an equation set is established according to the element node displacements, and undetermined coefficients a₁-a₂₀ are determined through the simultaneous solution. The constructed interpolation function has the two-order completeness, which is higher than the completeness of the conventional element displacement interpolation function by one order. The curved-surface hexahedral element can automatically degenerate into a curved-surface pentahedral element and a curved-surface quadrilateral element; and six quadrilateral side curved-surfaces can degenerate into triangular side curved-surfaces.

The compatibility problem of the element displacement interpolation function at the element boundary can divided into following three conditions.

(a) Common edge line compatibility of hexahedral element

Similar as the planar problem, it is required that the common edge line of the element is a straight line and nodes therein equally divide the common edge line, so that the element displacement interpolation function is compatible at the common edge line, which is irrelevant to shapes of other parts of the element.

(b) Quadrilateral side curved-surface compatibility of hexahedral element

It is required that the common quadrilateral side curved-surface of the element is a plane, four sides are all straight lines and nodes therein equally divide the boundary; and at the moment, the element displacement interpolation function is compatible at the common quadrilateral side plane, which is irrelevant to shapes of other faces of the element.

(c) Triangular side curved-surface compatibility of hexahedral element

It is merely required that the common triangular side curved-surface of the element is a plane, and the side of the triangle can be a curve, so that the element displacement interpolation function is compatible at the common triangular side plane, which is irrelevant to shapes of other faces of the element. The side of the triangle can be the curve, which enables the construction of the degenerated quadrilateral element suitable for any curved boundary to be possible.

When element dividing, the planar hexahedral element is applied in the internal structure, and the exposed curved-surface of the degenerated quadrilateral element, pentahedral element and hexahedral element can be applied in simulating the external curved-surface boundary of the structure, so that the compatibility of the element displacement interpolation function is guaranteed and meanwhile the curved-surface boundary of the structure is well simulated. The element dividing method is consistent with the conventional element dividing method and does not have the increased difficulty.

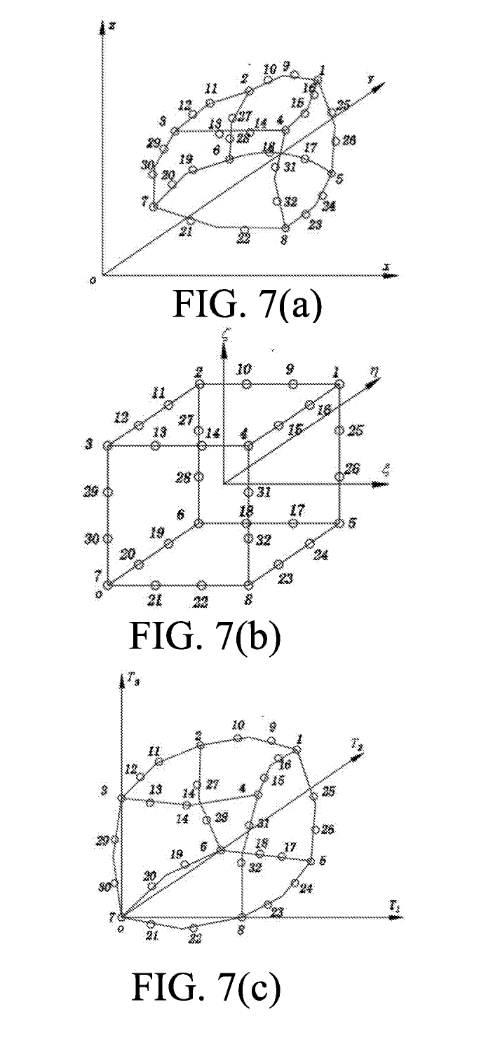

4) As shown in FIG. 7(a), FIG. 7(b) and FIG. 7(c), when the target solid element is a three-dimensional thirty-two-node high-order complete compatible curved-surface hexahedral element, the constructed element displacement interpolation function is that:

u(v,w)=a₁+a₂T₁+a₃T₂+a₄T₃+a₅T₁²+a₆T₂²+a₇T₃²+a₈T₁T₂+a₉T₁T₃a+a₁₀T₂T₃a₁₁T₁³+a₁₂T₂³+a₁₃T₃³+a₁₄T₁²T₂+a₁₅T₁²T₃+a₁₆T₁T₂²+a₁₇T₂²T₃+a₁₈T₁T₃²+a₁₉T₂T₃²+a₂₀T₁T₂T₃+a₂₁ξ³ηζ+a₂₂ξ³ζ+a₂₃ξη³+a₂₄η³ζ+a₂₅ξζ³+a₂₆ηζ³+a₂₇ξ²ηζ+a₂₈ξη²ζ+a₂₉ξηζ²+a₃₀ξ²η²+a₃₁ξ²ζ²+a₃₂η²ζ²

For the element displacement interpolation function, an equation set is established according to the element node displacements, and undetermined coefficients a₁-a₃₂ are determined through the simultaneous solution. The constructed interpolation function has the third-order completeness, which is higher than the completeness of the conventional element displacement interpolation function by two orders. The curved-surface hexahedral element can automatically degenerate into a curved-surface pentahedral element and a curved-surface quadrilateral element; and six quadrilateral side curved-surfaces can degenerate into triangular side curved-surfaces to be suitable for the curved-surface structure boundary.

The compatibility problem of the element displacement interpolation function at the element boundary can divided into following three conditions.

(a) Common Edge Line Compatibility of Hexahedral Element

Similar as the planar problem, it is required that the common edge line of the element is a straight line and nodes therein equally divide the common edge line, so that the element displacement interpolation function is compatible at the common edge line, which is irrelevant to shapes of other parts of the element.

(b) Quadrilateral Side Curved-Surface Compatibility of Hexahedral Element

It is required that the common quadrilateral side curved-surface of the element is a plane, four sides are all straight lines and nodes therein equally divide the boundary; and at the moment, the element displacement interpolation function is compatible at the common quadrilateral side plane, which is irrelevant to shapes of other faces of the element.

(c) Triangular Side Curved-Surface Compatibility of Hexahedral Element

It is merely required that the common triangular side curved-surface of the element is a plane, and the side of the triangle can be a curve, so that the element displacement interpolation function is compatible at the common triangular side plane, which is irrelevant to shapes of other faces of the element. The side of the triangle can be the curve, which enables the construction of the degenerated quadrilateral element suitable for any curved boundary to be possible.

When element dividing, the planar hexahedral element is applied in the internal structure, and the exposed curved-surface of the degenerated quadrilateral element, pentahedral element and hexahedral element can be applied in simulating the external curved-surface boundary of the structure, so that the compatibility of the element displacement interpolation function is guaranteed and meanwhile the curved-surface boundary of the structure is well simulated. The element dividing method is consistent with the conventional element dividing method and does not have the increased difficulty.

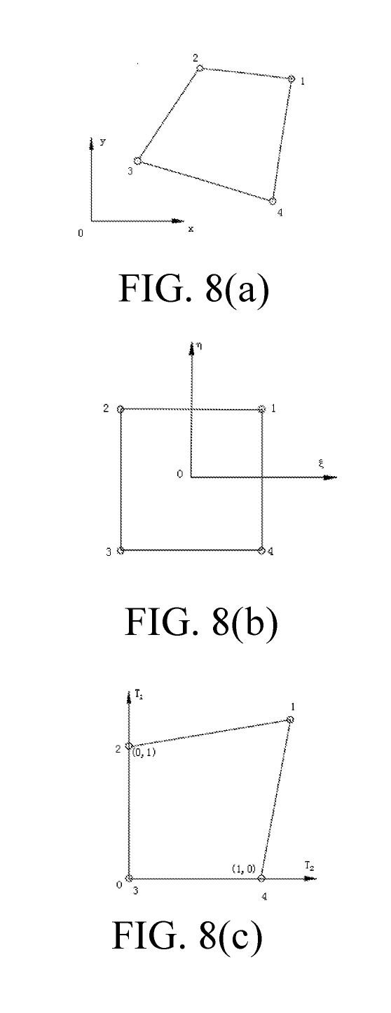

5) As shown in FIG. 8(a), FIG. 8(b) and FIG. 8(c), when the target solid element is a two-dimensional four-node high-order complete compatible quadrilateral thin-plate element with every node having three related displacement components (the related displacement components are w,θₓ,θ_{y}, and a total displacement number is product of the known node number and the node displacement component number), the constructed element displacement interpolation function is that:

w=a₁+a₂T₁+a₃T₂+a₄T₁²+a₅T₁T₂+a₆T₂²+a₇T₁³+a₈T₁²T₂+a₉T₁T₂²+a₁₀T₂³+a₁₁ξ³η+a₁₂ξη².

For the element displacement interpolation function, an equation set is established according to the element node displacements, and undetermined coefficients a₁-a₁₂ are determined through the simultaneous solution. The constructed interpolation function has the third-order completeness, which is relatively high. The constructed element displacement interpolation function has the compatible deflection and tangential corner at the common boundary of the adjacent element; in comparison, the conventional quadrilateral thin-plate element can only be the rectangular element and the triangular element, which is not suitable for the broken-line boundary and has the limited application range.

The element displacement interpolation function has the compatible deflection and tangential corner at the element boundary, while the normal corner thereof is incompatible. The above problem is namely the C¹-order non-compatibility problem, which is always considered as the unsolvable difficult problem. Therefore, according to the preferred embodiment, in the regular isoparametric coordinate system, a specific modified function modifies the incompatible normal corner of only one boundary of the element, without affecting the displacements and the corner values of the other boundaries of the element, and more importantly, without affecting the normal corner values of the other boundaries of the element. Thus, merely the incompatible normal corner at the common boundary of the element is required to be modified, and the incompatible normal corner at the free boundary of the element is not required to be modified.

Preferably, according to the preferred embodiment, the incompatible normal corner displacement at the boundary of the element is modified through the following equation of:

$$Δ w = - \frac{( 1 - {η}^{2} ) ( 1 + ξ ) {( 1 - ξ )}^{2}}{4 ( 2 + ξ + η ) ( 2 + ξ - η )} Δ {θ}_{η 23} ( η ) + \frac{( 1 - {η}^{2} ) ( 1 - ξ ) {( 1 + ξ )}^{2}}{4 ( 2 - ξ + η ) ( 2 - ξ - η )} Δ {θ}_{η 14} ( η ) + \frac{( 1 - {ξ}^{2} ) ( 1 + η ) {( 1 - η )}^{2}}{4 ( 2 + ξ + η ) ( 2 - ξ + η )} Δ {θ}_{ξ 34} ( ξ ) - \frac{( 1 - {ξ}^{2} ) ( 1 - η ) {( 1 + η )}^{2}}{4 ( 2 + ξ - η ) ( 2 - ξ - η )} Δ {θ}_{ξ 12} ( ξ ) ; wherein \text{:}$$

Δθ_{η23}(η), Δθ_{η14}(η), Δθ_{ξ34}(ξ) and Δθ_{ξ12}(ξ) are the incompatible normal corner displacements of four boundaries of the element, which are zero at the node; and the incompatible normal corner displacement of any boundary can be selectively modified.

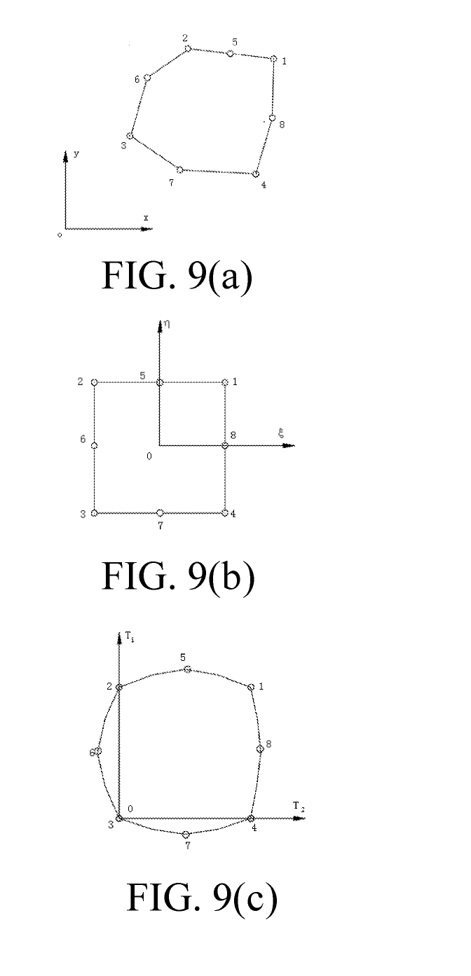

6) As shown in FIG. 9(a), FIG. 9(b) and FIG. 9(c), when the target solid element is a two-dimensional eight-node high-order complete compatible curved quadrilateral thin-plate element with every node having three related displacement components, the constructed element displacement interpolation function is that:

w=a₁+a₂T₁+a₃T₂+a₄T₁²+a₅T₁T₂+a₆T₂²+a₇T₁³+a₈T₁²T₂+a₉T₁T₂²+a₁₀T₂³+a₁₁T₁⁴+a₁₂T₁³T₂+a₁₃T₁²T₂²+a₁₄T₁T₂³+a₁₅T₂⁴+a₁₆T₁⁵+a₁₇T₁⁴T₂+a₁₈T₁³T₂²+a₁₉T₁²T₂³+a₂₀T₁T₂⁴+a₂₁T₂⁵+a₂₂ξ⁴η²+a₂₃ξ³η³+a₂₄ξ²η⁴

For the element displacement interpolation function, an equation set is established according to the element node displacements, and undetermined coefficients a₁-a₂₄ are determined through the simultaneous solution. The constructed interpolation function has the fifth-order completeness, which is relatively high and suitable for any curvilinear boundary. When element dividing, it is merely required that the common boundary of two adjacent elements is kept to be a straight line and the nodes in the boundary equally divide the boundary, without any compatibility requirement on free outer boundary of the element that the free outer boundary can be a curve, so as to be suitable for the curvilinear boundary. At the moment, the element displacement interpolation function has the compatible deflection and tangential corner at the common boundary of the element, while the normal corner thereof is incompatible and required to be modified.

When the common boundary of two adjacent elements is a straight line and nodes in the boundary equally divide the boundary, the element displacement interpolation function has the compatible deflection and tangential corner at the element boundary; however, the normal corner thereof is incompatible, which is namely the C¹-order non-compatibility problem and always considered as the unsolvable difficult problem. Therefore, according to the preferred embodiment, in the regular isoparametric coordinate system, a specific modified function can modify the incompatible normal corner of only one boundary of the element, without affecting the deflections and the tangential corner values of the other boundaries of the element, and more importantly, without affecting the normal corner values of the other boundaries of the element. Merely the incompatible normal corner at the common boundary of the element is required to be modified, and the incompatible normal corner at the free boundary of the element is not required to be modified. Thus, the outer boundary of the element can be a curve, so as to be suitable for the curvilinear boundary. Preferably, according to the preferred embodiment, the incompatible normal corner displacement at the boundary of the element is modified through the following equation of:

$$Δ w = - \frac{( 1 - {η}^{2} ) ( 1 + ξ ) {( 1 - ξ )}^{2}}{4 ( 2 + ξ + η ) ( 2 + ξ - η )} Δ {θ}_{η 23} ( η ) + \frac{( 1 - {η}^{2} ) ( 1 - ξ ) {( 1 + ξ )}^{2}}{4 ( 2 - ξ + η ) ( 2 - ξ - η )} Δ {θ}_{η 14} ( η ) + \frac{( 1 - {ξ}^{2} ) ( 1 + η ) {( 1 - η )}^{2}}{4 ( 2 + ξ + η ) ( 2 - ξ + η )} Δ {θ}_{ξ 34} ( ξ ) - \frac{( 1 - {ξ}^{2} ) ( 1 - η ) {( 1 + η )}^{2}}{4 ( 2 + ξ - η ) ( 2 - ξ - η )} Δ {θ}_{ξ 12} ( ξ ) ; wherein \text{:}$$

Δθ_{η23}(η), Δθ_{η14}(η), Δθ_{ξ34}(ξ) and Δθ_{ξ12}(ξ) are the incompatible normal corner displacements of element boundaries, which are zero at the node; and the incompatible normal corner displacement of any boundary can be selectively modified.

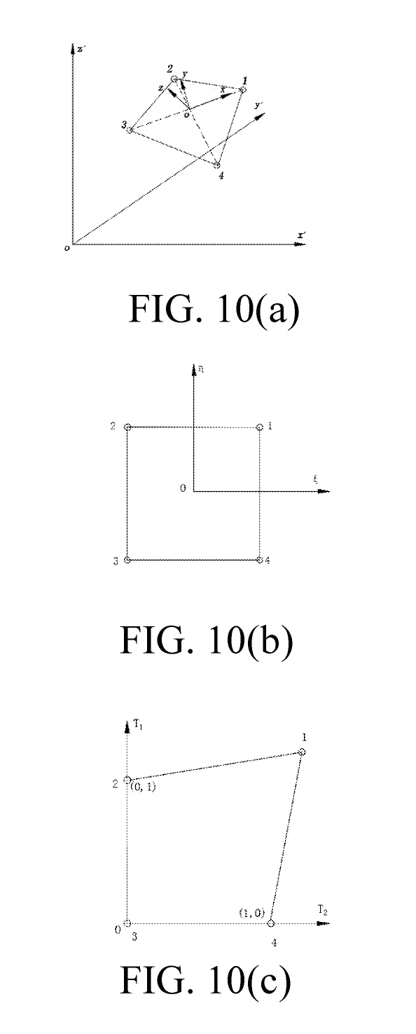

7) When the target solid element is a three-dimensional four-node high-order complete compatible quadrilateral flat-plate thin-shell element (relating to w,θₓ,θ_{y}), for any four-node plane quadrilateral thin-shell element, as shown in FIG. 10(a), FIG. 10(b) and FIG. 10(c), the displacement interpolation function of any quadrilateral plane thin-plate element can be transformed into the spatial thin-shell element displacement interpolation function through the coordinate transformation, wherein: the transformation relation of the node displacement vector between two coordinate systems is that:

$${a}_{i}^{′} = La ; {a}_{i} = {L}^{T} {a}_{i}^{′} {a}_{i} = [ \begin{matrix}{u}_{i} & {v}_{i} & {w}_{i} & {θ}_{xi} & {θ}_{yi} & {θ}_{zi}\end{matrix} ] ;$$

$${a}_{i}^{′} = [ \begin{matrix}{u}_{i}^{′} & {v}_{i}^{′} & {w}_{i}^{′} & {θ}_{xi}^{′} & {θ}_{yi}^{′} & {θ}_{zi}^{′}\end{matrix} ]$$

$$T = [ \begin{matrix}L & 0 & 0 \\ 0 & L & 0 \\ 0 & 0 & L\end{matrix} ] , L = [ \begin{matrix}λ & 0 \\ 0 & λ\end{matrix} ] , λ = [ \begin{matrix}{λ}_{{x}^{′} x} & {λ}_{{x}^{′} y} & {λ}_{{x}^{′} z} \\ {λ}_{{y}^{′} x} & {λ}_{{y}^{′} y} & {λ}_{{y}^{′} z} \\ {λ}_{{z}^{′} x} & {λ}_{{z}^{′} y} & {λ}_{{z}^{′} z}\end{matrix} ] ;$$

wherein

aᵢ′, aᵢ are node displacements; and T, L, λ are transformation matrixes.

A transformation relation between the element stiffness matrix and load column vector is that:

K′^{e}=TK^{e}T;Q′^{e}=TQ.

Other transformation relations are implemented through conventional methods.

For the construction of the quadrilateral thin-shell element displacement interpolation function, based on the method of combining the linear transformation coordinate system with the isoparametric coordinate system, the element displacement interpolation function is assumed to be:

$$\{ \begin{matrix}u ( v ) = {a}_{1} + {a}_{2} {T}_{1} + {a}_{3} {T}_{2} + {a}_{4} ξ η \\ w = \begin{matrix}{a}_{1} + {a}_{2} {T}_{1} + {a}_{3} {T}_{2} + {a}_{4} {T}_{1}^{2} + {a}_{5} {T}_{1} {T}_{2} + {a}_{6} {T}_{2}^{2} + {a}_{7} {T}_{1}^{3} + \\ {a}_{8} {T}_{1}^{2} {T}_{2} + {a}_{9} {T}_{1} {T}_{2}^{2} + {a}_{10} {T}_{2}^{3} + {a}_{11} {ξ}^{3} η + {a}_{12} ξ {η}^{3}\end{matrix}\end{matrix} .$$

For the element displacement interpolation function, an equation set is established according to the element node displacements, and undetermined coefficients are determined through the simultaneous solution. The constructed interpolation function has the third-order completeness, which is relatively high; and moreover, the thin-shell element displacement interpolation function has the compatible deflection and tangential corner at the common boundary of the adjacent elements.

The thin-shell element displacement interpolation function has the compatible deflection and tangential corner at the element boundary. However, the normal corner of the thin-shell element displacement interpolation function is incompatible, which is namely the C¹-order non-compatibility problem. Therefore, according to the preferred embodiment, in the regular isoparametric coordinate system, a specific modified function modifies the incompatible normal corner of only one boundary of the element, without affecting the deflections and the tangential corner values of the other boundaries of the element, and more importantly, without affecting the normal corner values of the other boundaries of the element. Thus, merely the incompatible normal corner at the common boundary of the element is required to be modified, and the incompatible normal corner at the free boundary of the element is not required to be modified.

Preferably, according to the preferred embodiment, the incompatible normal corner displacement at the boundary of the thin-shell element is modified through the following equation of:

$$Δ w = - \frac{( 1 - {η}^{2} ) ( 1 + ξ ) {( 1 - ξ )}^{2}}{4 ( 2 + ξ + η ) ( 2 + ξ - η )} Δ {θ}_{η 23} ( η ) + \frac{( 1 - {η}^{2} ) ( 1 - ξ ) {( 1 + ξ )}^{2}}{4 ( 2 - ξ + η ) ( 2 - ξ - η )} Δ {θ}_{η 14} ( η ) + \frac{( 1 - {ξ}^{2} ) ( 1 + η ) {( 1 - η )}^{2}}{4 ( 2 + ξ + η ) ( 2 - ξ + η )} Δ {θ}_{ξ 34} ( ξ ) - \frac{( 1 - {ξ}^{2} ) ( 1 - η ) {( 1 + η )}^{2}}{4 ( 2 + ξ + η ) ( 2 - ξ - η )} Δ {θ}_{ξ 12} ( ξ ) ; wherein \text{:} \qquad$$

Δθ_{η23}(η), Δθ_{η14}(η), Δθ_{ξ34}(ξ) and Δθ_{ξ12}(ξ) are the incompatible normal corner displacements of element boundaries, which are zero at the node; and the incompatible normal corner displacement of any boundary of the element can be selectively modified.

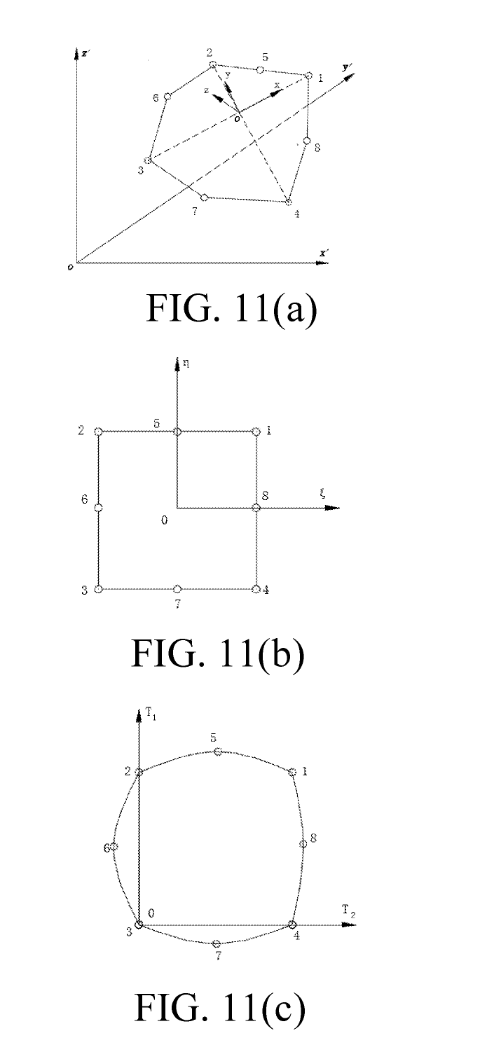

8) When the target solid element is a three-dimensional eight-node high-order complete compatible curvilinear quadrilateral flat-plate thin-shell element (relating to w,θₓ,θ_{y}), for any eight-node plane quadrilateral thin-shell element, as shown in FIG. 11(a), FIG. 11(b) and FIG. 11(c), the displacement interpolation function of any quadrilateral plane thin-plate element can be transformed into the spatial thin-shell element displacement interpolation function through the coordinate transformation, wherein the transformation relation of the node displacement vector between two coordinate systems is that:

$${a}_{i}^{′} = La ; {a}_{i} = {L}^{T} {a}_{i}^{′}$$

$${a}_{i} = [ \begin{matrix}{u}_{i} & {v}_{i} & {w}_{i} & {θ}_{xi} & {θ}_{yi} & {θ}_{zi}\end{matrix} ] ;$$

$${a}_{i}^{′} = [ \begin{matrix}{u}_{i}^{′} & {v}_{i}^{′} & {w}_{i}^{′} & {θ}_{xi}^{′} & {θ}_{yi}^{′} & {θ}_{zi}^{′}\end{matrix} ]$$

$$T = [ \begin{matrix}L & 0 & 0 \\ 0 & L & 0 \\ 0 & 0 & L\end{matrix} ] , L = [ \begin{matrix}λ & 0 \\ 0 & λ\end{matrix} ] , λ = [ \begin{matrix}{λ}_{{x}^{′} x} & {λ}_{{x}^{′} y} & {λ}_{{x}^{′} z} \\ {λ}_{{y}^{′} x} & {λ}_{{y}^{′} y} & {λ}_{{y}^{′} z} \\ {λ}_{{z}^{′} x} & {λ}_{{z}^{′} y} & {λ}_{{z}^{′} z}\end{matrix} ] ;$$

aᵢ′, aᵢ, are node displacements; and T, L, λ are transformation matrixes.

A transformation relation between the element stiffness matrix and load column vector is that:

K′^{e}=TK^{e}T;Q′^{e}=TQ.

Other transformation relations are implemented through conventional methods.

For the construction of the quadrilateral thin-shell element displacement interpolation function, based on the method of combining the linear transformation coordinate system with the isoparametric coordinate system, the element displacement interpolation function is assumed to be:

$$\{ \begin{matrix}u ( v ) = \begin{matrix}{a}_{1} + {a}_{2} {T}_{1} + {a}_{3} {T}_{2} + {a}_{4} {T}_{1}^{2} + {a}_{5} {T}_{1} {T}_{2} + \\ {a}_{6} {T}_{2}^{2} + {a}_{7} {ξ}^{2} η + {a}_{8} ξ {η}^{2}\end{matrix} \\ w = \begin{matrix}{a}_{1} + {a}_{2} {T}_{1} + {a}_{3} {T}_{2} + {a}_{4} {T}_{1}^{2} + {a}_{5} {T}_{1} {T}_{2} + {a}_{6} {T}_{2}^{2} + {a}_{7} {T}_{1}^{3} + \\ {a}_{8} {T}_{1}^{2} {T}_{2} + {a}_{9} {T}_{1} {T}_{2}^{2} + {a}_{10} {T}_{2}^{3} + {a}_{11} {T}_{1}^{4} + {a}_{12} {T}_{1}^{3} {T}_{2} + \\ {a}_{13} {T}_{1}^{2} {T}_{2}^{2} + {a}_{14} {T}_{1} {T}_{2}^{3} + {a}_{15} {T}_{2}^{4} + {a}_{16} {T}_{1}^{5} + {a}_{17} {T}_{1}^{4} {T}_{2} + \\ {a}_{18} {T}_{1}^{3} {T}_{2}^{2} + {a}_{19} {T}_{1}^{2} {T}_{2}^{3} + {a}_{20} {T}_{1} {T}_{2}^{4} + {a}_{21} {T}_{2}^{5} + {a}_{22} {ξ}^{4} {η}^{2} + \\ {a}_{23} {ξ}^{3} {η}^{3} + {a}_{24} {ξ}^{2} {η}^{4}\end{matrix}\end{matrix} .$$

For the element displacement interpolation function, an equation set is established according to the element node displacements, and undetermined coefficients are determined through the simultaneous solution. The constructed interpolation function has the fifth-order completeness, which is relatively high and suitable for the curvilinear boundary. When element dividing, it is merely required that the common boundary of the two adjacent elements is kept to be a straight line and nodes in the boundary equally divide the boundary, without any compatibility requirement on free outer boundary of the element that the free outer boundary can be a curve, so as to be suitable for the curvilinear boundary. At the moment, the element displacement interpolation function has the compatible deflection and tangential corner at the common boundary of the element, while the normal corner thereof is incompatible and required to be modified.

When the common boundary of two adjacent elements is a straight line and the nodes in the boundary equally divide the boundary, the element displacement interpolation function has the compatible deflection and tangential corner at the element boundary. However, the normal corner of the element displacement interpolation function is incompatible, which is namely the C¹-order non-compatibility problem. Therefore, according to the preferred embodiment, in the regular isoparametric coordinate system, a specific modified function modifies the incompatible normal corner of only one boundary of the element, without affecting the deflections and the tangential corner values of the other boundaries of the element, and more importantly, without affecting the normal corner values of the other boundaries of the element. Thus, merely the incompatible normal corner at the common boundary of the element is required to be modified, and the incompatible normal corner at the free boundary of the element is not required to be modified.

Preferably, according to the preferred embodiment, the incompatible normal corner displacement at the boundary of the thin-shell element is modified through the following equation of:

$$Δ w = - \frac{( 1 - {η}^{2} ) ( 1 + ξ ) {( 1 - ξ )}^{2}}{4 ( 2 + ξ + η ) ( 2 + ξ - η )} Δ {θ}_{η 23} ( η ) + \frac{( 1 - {η}^{2} ) ( 1 - ξ ) {( 1 + ξ )}^{2}}{4 ( 2 - ξ + η ) ( 2 - ξ - η )} Δ {θ}_{η 14} ( η ) + \frac{( 1 - {ξ}^{2} ) ( 1 + η ) {( 1 - η )}^{2}}{4 ( 2 + ξ + η ) ( 2 - ξ + η )} Δ {θ}_{ξ 34} ( ξ ) - \frac{( 1 - {ξ}^{2} ) ( 1 - η ) {( 1 + η )}^{2}}{4 ( 2 + ξ - η ) ( 2 - ξ - η )} Δ {θ}_{ξ 12} ( ξ ) ; wherein \text{:} \qquad$$

Δθ_{η23}(η), Δθ_{η14}(η), Δθ_{ξ34}(ξ) and Δθ_{ξ12}(ξ) are the incompatible normal corner displacements of element boundaries, which are zero at the node; and the incompatible normal corner displacement of any boundary of the element can be selectively modified.

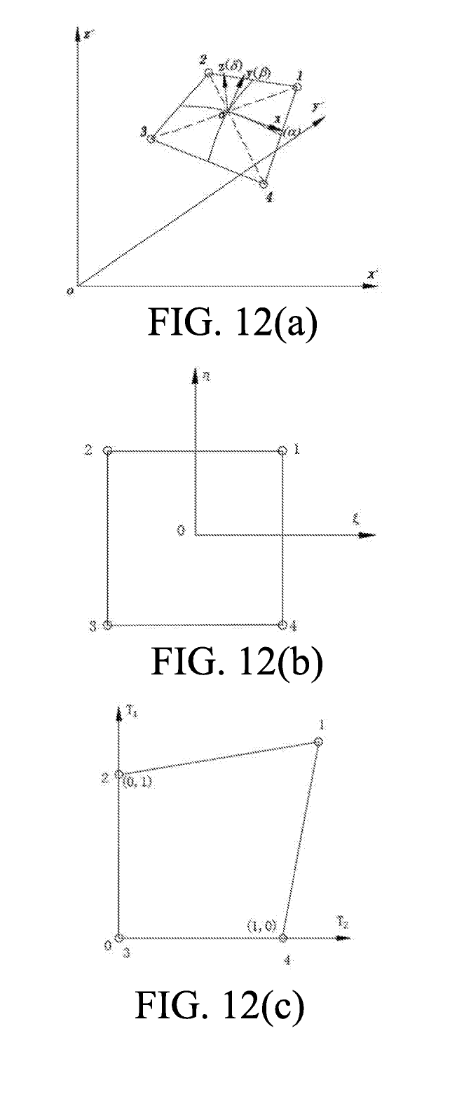

9) When the target solid element is a three-dimensional four-node high-order complete compatible quadrilateral curved-surface thin-shell element (relating to w,θₓ,θ_{y}), as shown in FIG. 12(a), FIG. 12(b) and FIG. 12(c), global coordinates of any point in the curved-surface thin-shell element is that:

$$\{ \begin{matrix}x \\ y \\ z\end{matrix} \} = {\sum }_{i = 1}^{4} {N}_{i} ( ξ , η ) [ \begin{matrix}{x}_{i} \\ {y}_{i} \\ {z}_{i}\end{matrix} ] ;$$

wherein:

Nᵢ(ξ, η) is a conventional shape function.

In the global coordinate system, the rigid-body displacement {δ_{Ri}′} of the node is given by the rigid-body motion of the element microbody, and the motion of the microbody centroid comprises the rotation around three coordinate axes and the translational motion along the coordinate axes. The rigid-body motion of the centroid of the curved-surface thin-shell element is that:

{V_{R}′}={u₀′v₀′w₀′θₓ₀′θ_{y0}′θ_{z0}′}^{T}.

In the global coordinate system, the node rigid-body displacement generated by the rigid-body motion through the dynamical method is that:

{δ_{Ri}′}={u_{Ri}′v_{Ri}′w_{Ri}′θ_{xRi}′θ_{yRi}′θ_{zRi}′}^{T}=[T_{Ri}]{V_{R}′}

{δ_{R}′^{e}}={δ_{R1}′δ_{R2}′δ_{R3}′δ_{R4}′}^{T}=[T_{R}]{V_{R}′}; wherein:

the sub-matrix of the transformation matrix T_{R} is that:

$$[ {T}_{R} ] = {\{ \begin{matrix}{T}_{R 1} & {T}_{R 2} & {T}_{R 3} & {T}_{R 4}\end{matrix} \}}^{T} \\ [ {T}_{Ri} ] = [ \begin{matrix}1 & 0 & 0 & 0 & {z}_{i} - {z}_{0} & - ( {y}_{i} - {y}_{0} ) \\ 0 & 1 & 0 & - ( {z}_{i} - {z}_{0} ) & 0 & {x}_{i} - {x}_{0} \\ 0 & 0 & 1 & {y}_{i} - {y}_{0} & - ( {x}_{i} - {x}_{0} ) & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] ;$$

in the equation, x₀,y₀,z₀ are global coordinates of the element microbody centroid.

In the curvilinear coordinate system, the node rigid-body displacement generated by the rigid-motion is that:

{δ_{Ri}}={u_{Ri}v_{Ri}w_{Ri}θ_{xRi}θ_{yRi}θ_{zRi}}^{T}=[Lᵢ][T_{Ri}][L₀]^{T}{V_{R}}

{δ_{R}^{e}}={δ_{R1}δ_{R2}δ_{R2}δ_{R4}}^{T}=[T]^{T}[T_{R}][L₀]^{T}{V_{R}};

wherein: Lᵢ is the transformation matrix.

In the following equations of:

$$[ T ] = [ \begin{matrix}{L}_{1} & 0 & 0 & 0 \\ 0 & {L}_{2} & 0 & 0 \\ 0 & 0 & {L}_{3} & \\ 0 & 0 & 0 & {L}_{4}\end{matrix} ]$$

$${L}_{i} = [ \begin{matrix}{λ}_{i} & 0 \\ 0 & {λ}_{i}\end{matrix} ] , {λ}_{i} = [ \begin{matrix}{λ}_{{x}^{′} α i} & {λ}_{{x}^{′} β i} & {λ}_{{x}^{′} δ i} \\ {λ}_{{y}^{′} α i} & {λ}_{{y}^{′} β i} & {λ}_{{y}^{′} δ i} \\ {λ}_{{z}^{′} α i} & {λ}_{{z}^{′} β i} & {λ}_{{z}^{′} δ i}\end{matrix} ] i = 0 , 1 , 2 … , n ,$$

λ_{x′ai}=cos(x′,α) is the direction cosine of x-axis, y-axis and z-axis in the orthogonal principle-curve coordinate system of α,β,δ.

In the curvilinear coordinate system, the rigid-body motion of the centroid of the curved-surface thin-shell element is that:

{V_{R}}={u₀v₀w₀θₓ₀θ_{y0}θ_{z0}}^{T}.

The transformation relation of the element node displacement vector between the global coordinates and the curvilinear coordinates is that:

{V_{R}′}=[L₀]{V_{R}}{δ_{R}′^{e}}=[T]{δ_{T}^{e}}

{δ′_{D}^{e}}=[T]{δ_{D}^{e}}{δ′_{D}^{e}}=[T][T_{R}][L]{V_{R}}.

In the curvilinear coordinate system, the element displacement after supplementing the rigid-body displacement is that:

$$\{ {δ}_{T}^{e} \} = \{ {δ}_{D}^{e} \} + \{ {δ}_{R}^{e} \} = [ \begin{matrix}I & {T}_{R}\end{matrix} ] \{ \begin{matrix}{δ}_{D}^{e} \\ {V}_{R}\end{matrix} \} ;$$

wherein I is an element matrix of 20×20.

Because the rigid-body displacement does not generate the strain, the strain matrix in the orthogonal principle-curve coordinate system is that:

{ε^{e}}=[B]{δ_{D}^{e}}; wherein:

B is the strain matrix of the element in the orthogonal principle-curve coordinate system.

The rigid-body displacement does not generate the node force which leads to the static condensation, and the following finite element equation is established according to a virtual work principle that:

$$\{ \begin{matrix}{P}_{D}^{e} \\ 0\end{matrix} \} = [ {K}_{T}^{e} ] \{ \begin{matrix}{δ}_{T}^{e} \\ - {V}_{R}\end{matrix} \} = [ \begin{matrix}{K}_{11} & {K}_{12} \\ {K}_{21} & {K}_{22}\end{matrix} ] \{ \begin{matrix}{δ}_{T}^{e} \\ - {V}_{R}\end{matrix} \} ;$$

wherein:

└P_{D}^{e}┘ is the node load of the element in the orthogonal principle-curve coordinate system; [K_{T}^{e}] is obtained by the original stiffness matrix [K_{D}^{e}] of the element in the orthogonal principle-curve coordinate system after the displacement extension, namely

$$[ {K}_{T}^{e} ] = \{ \begin{matrix}I \\ {T}_{R}^{T}\end{matrix} \} [ {K}_{D}^{e} ] \{ \begin{matrix}I & {T}_{R}\end{matrix} \} = [ \begin{matrix}{K}_{11} & {K}_{12} \\ {K}_{21} & {K}_{22}\end{matrix} ] ;$$

wherein

[K₁]_{20×20}=[K_{D}^{e}][K₁₂]_{20×6}=[K₂₁]^{T}=[K_{D}^{e}][T_{R}],[K₂₂]_{6×6}=[T_{R}]^{T}[K_{D}^{e}][T_{R}];

{V_{R}}=[K₂₂]⁻¹[K₂₁]{δ_{T}^{e}},{P_{D}^{e}}=([K₁₁]−[K₁₂][K₂₂]⁻¹[K₂₁]){δ_{T}^{e}};

{ε^{e}}=[B]*{δ_{R}^{e}};

the transformation relation between the stiffness matrix and the load vector in the global coordinate system is that:

[K′^{e}]=[T][K_{T}^{e}][T]^{T},[P′]^{e}=[T][P′_{D}^{e}];

and through integrating the stiffness matrix and the load vector of each element in the global coordinate system, the node displacement solving equation of the global coordinate system is obtained.

In the orthogonal principle-curve coordinate system of (α,β,δ), α,β,δ are arc lengths of the curvilinear coordinates. For any four-node quadrilateral element, as shown in FIG. 11, based on the creative method of combining the linear transformation coordinate system with the isoparametric coordinate system, the curvilinear arc length coordinates are processed with the linear coordinate transformation and the isoparametric coordinate transformation as the planar thin-plate problem, and the element displacement interpolation function is assumed to be:

$$\{ \begin{matrix}u ( v ) = {a}_{1} + {a}_{2} {T}_{1} + {a}_{3} {T}_{2} + {a}_{4} ξη \\ \begin{matrix}w = {a}_{1} + {a}_{2} {T}_{1} + {a}_{3} {T}_{2} + {a}_{4} {T}_{1}^{2} + {a}_{5} {T}_{1} {T}_{2} + {a}_{6} {T}_{2}^{2} + {a}_{7} {T}_{1}^{3} + \\ {a}_{8} {T}_{1}^{2} {T}_{2} + {a}_{9} {T}_{1} {T}_{2}^{2} + {a}_{10} {T}_{2}^{3} + {a}_{11} {ξ}^{3} η + {a}_{12} {ξη}^{3}\end{matrix}\end{matrix} .$$

An equation set is established according to the element node displacements, and undetermined coefficients are determined through the simultaneous solution. The constructed interpolation function has the third-order completeness, which is relatively high. The element displacement interpolation function has the compatible deflection and tangential corner at the common boundary of the adjacent element; however, the normal corner of the interpolation function is incompatible, which is namely the C¹-order non-compatibility problem. Therefore, according to the preferred embodiment, in the regular isoparametric coordinate system, a specific modified function modifies the incompatible normal corner of only one boundary of the element, without affecting the displacements and the corner values of the other boundaries of the element, and more importantly, without affecting the normal corner values of the other boundaries of the element. Thus, merely the incompatible normal corner at the common boundary of the element is required to be modified, and the incompatible normal corner at the free boundary of the element is not required to be modified.

Preferably, according to the preferred embodiment, the incompatible normal corner displacement at the boundary of the element is modified through the following equation of:

$$Δ w = - \frac{( 1 - {η}^{2} ) ( 1 + ξ ) {( 1 - ξ )}^{2}}{4 ( 2 + ξ + η ) ( 2 + ξ - η )} {Δθ}_{η23} ( η ) + \frac{( 1 - {η}^{2} ) ( 1 - ξ ) {( 1 + ξ )}^{2}}{4 ( 2 - ξ + η ) ( 2 - ξ - η )} {Δθ}_{η14} ( η ) + \frac{( 1 - {ξ}^{2} ) ( 1 + η ) {( 1 - η )}^{2}}{4 ( 2 + ξ + η ) ( 2 - ξ + η )} {Δθ}_{η34} ( ξ ) - \frac{( 1 - {ξ}^{2} ) ( 1 - η ) {( 1 + η )}^{2}}{4 ( 2 + ξ - η ) ( 2 - ξ - η )} {Δθ}_{η12} ( ξ ) ;$$

$$wherein \text{:}$$

Δθ_{η23}(η), Δθ_{η14}(η), Δθ_{ξ34}(ξ) and Δθ_{ξ12}(ξ) are the incompatible normal corner displacements of four boundaries of the element, which are zero at the node; and the incompatible normal corner displacement of any boundary of the element can be selectively modified.

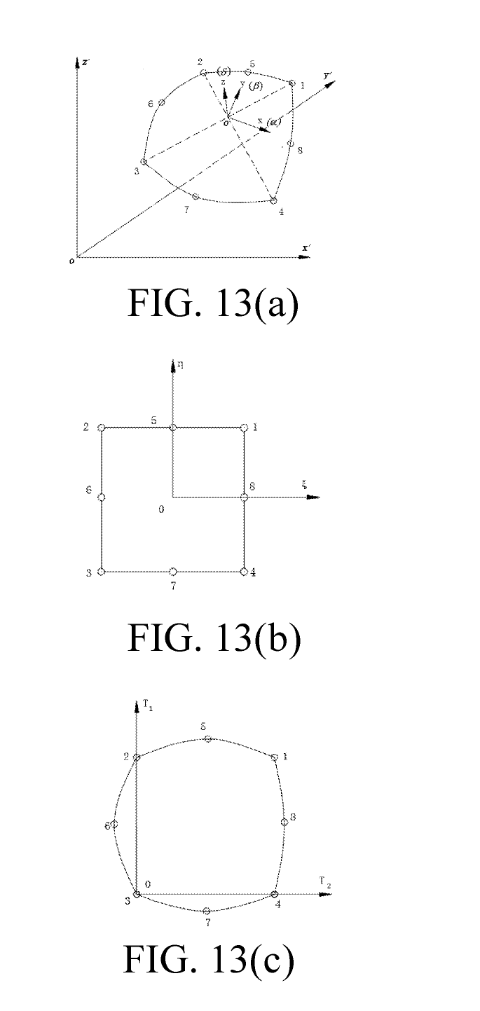

10) When the target solid element is a three-dimensional eight-node high-order complete compatible quadrilateral curved-surface thin-shell element (relating to w,θₓ,θ_{y}), namely the eight-node curved-surface thin-shell element, as shown in FIG. 13(a), FIG. 13(b) and FIG. 13(c), global coordinates of any point in the curved-surface thin-shell element is that:

$$\{ \begin{matrix}x \\ y \\ z\end{matrix} \} = {\sum }_{i = 1}^{8} {N}_{i} ( ξ , η ) [ \begin{matrix}{x}_{i} \\ {y}_{i} \\ {z}_{i}\end{matrix} ] ;$$

wherein:

Nᵢ(ξ, η) is a conventional shape function.

In the global coordinate system, the rigid-body displacement {δ_{Ri}′} of the node is given by the rigid-body motion of the element microbody, and the motion of the microbody centroid comprises the rotation around three coordinate axes and the translational motion along the coordinate axes. The rigid-body motion of the centroid of the curved-surface thin-shell element is that:

{V_{R}′}={u₀′v₀′w₀′θₓ₀′θ_{y0}′θ_{z0}′}^{T}.

In the global coordinate system, the node rigid-body displacement generated by the rigid-body motion through the dynamical method is that:

{δ_{Ri}′}={u_{Ri}′v_{Ri}′w_{Ri}′θ_{xRi}′θ_{yRi}′θ_{zRi}′}^{T}=[T_{Ri}]{V_{R}′}

{δ_{R}′^{e}}={δ_{R1}′δ_{R2}′δ_{R3}′δ_{R4}′δ_{R5}′δ_{R6}′δ_{R7}′δ_{R8}′}^{T}=[T]^{T}[T_{R}]{V_{R}′}; wherein:
the sub-matrix of the transformation matrix T_{R} is that:

$$[ {T}_{R} ] = {\{ \begin{matrix}{T}_{R 1} & {T}_{R 2} & {T}_{R 3} & {T}_{R 4} & {T}_{R 5} & {T}_{R 6} & {T}_{R 7} & {T}_{R 8}\end{matrix} \}}^{T} ; \\ [ {T}_{Ri} ] = [ \begin{matrix}1 & 0 & 0 & 0 & {z}_{i} - {z}_{0} & - ( {y}_{i} - {y}_{0} ) \\ 0 & 1 & 0 & - ( {z}_{i} - {z}_{0} ) & 0 & {x}_{i} - {x}_{0} \\ 0 & 0 & 1 & {y}_{i} - {y}_{0} & - ( {x}_{i} - {x}_{0} ) & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] ;$$

in the equation, x₀, y₀, z₀ are global coordinates of the element microbody centroid.

In the curvilinear coordinate system, the node rigid-body displacement generated by the rigid-motion is that:

{δ_{Ri}}={u_{Ri}v_{Ri}w_{Ri}θ_{xRi}θ_{yRi}θ_{zRi}}^{T}=[Lᵢ]^{T}[T_{Ri}][L₀]^{T}{V_{R}};

{δ_{R}^{e}}={δ_{R1}δ_{R2}δ_{R3}δ_{R4}δ_{R5}δ_{R6}δ_{R7}δ_{R8}}^{T}=[T]^{T}[T_{R}][L₀]^{T}{V_{R}′}; wherein:

wherein: Lᵢ is the transformation matrix.

In the following equations of:

$$[ T ] = [ \begin{matrix}{L}_{1} & 0 & … & 0 & 0 \\ 0 & {L}_{2} & … & 0 & 0 \\ … & … & … & … & … \\ 0 & 0 & … & {L}_{7} & 0 \\ 0 & 0 & … & 0 & {L}_{8}\end{matrix} ]$$

$${L}_{i} = [ \begin{matrix}{λ}_{i} & 0 \\ 0 & {λ}_{i}\end{matrix} ] , {λ}_{i} = [ \begin{matrix}{λ}_{{x}^{′} α i} & {λ}_{{x}^{′} β i} & {λ}_{{x}^{′} δ i} \\ {λ}_{{y}^{′} α i} & {λ}_{{y}^{′} β i} & {λ}_{{y}^{′} δ i} \\ {λ}_{{z}^{′} α i} & {λ}_{{z}^{′} β i} & {λ}_{{z}^{′} δ i}\end{matrix} ] ,$$

λ_{x′ai}=cos(x′,α) is the direction cosines of x-axis, y-axis and z-axis in the orthogonal principle-curve coordinate system of α,β,δ.

In the curvilinear coordinate system, the rigid-body motion of the centroid of the curved-surface thin-shell element is that:

{V_{R}}={u₀v₀w₀θₓ₀θ_{y0}θ_{z0}}^{T}.

The transformation relation of the element node displacement vector between the global coordinates and the curvilinear coordinates is that:

{V_{R}′}=[L₀]{V_{R}}{δ_{T}′^{e}}=[T]{δ_{T}^{e}}

{δ′_{D}^{e}}=[T]{δ_{D}^{e}}{δ′_{D}^{e}}=[T][T_{R}][L₀]{V_{R}}.

In the curvilinear coordinate system, the element displacement after supplementing the rigid-body displacement is that:

$$\{ {δ}_{T}^{e} \} = \{ {δ}_{D}^{e} \} + \{ {δ}_{R}^{e} \} = [ \begin{matrix}I & {T}_{R}\end{matrix} ] \{ \begin{matrix}{δ}_{D}^{e} \\ {V}_{R}\end{matrix} \} ;$$

wherein I is an element matrix of 40×40

The rigid-body displacement does not generate the strain, and the strain matrix in the orthogonal principle-curve coordinate system is that:

{ε^{e}}=[B]{δ_{D}^{e}}; wherein:

B is the strain matrix of the element in the orthogonal principle-curve coordinate system.

The rigid-body displacement does not generate the node force which leads to the static condensation, and the following finite element equation is established according to a virtual work principle that:

$$\{ \begin{matrix}{P}_{D}^{e} \\ 0\end{matrix} \} = [ {K}_{T}^{e} ] \{ \begin{matrix}{δ}_{T}^{e} \\ - {V}_{R}\end{matrix} \} = [ \begin{matrix}{K}_{11} & {K}_{12} \\ {K}_{21} & {K}_{22}\end{matrix} ] \{ \begin{matrix}{δ}_{T}^{e} \\ - {V}_{R}\end{matrix} \} ;$$

[P_{D}^{e}] is the node load of the element in the orthogonal principle-curve coordinate system; [K_{T}^{e}] is obtained by the original stiffness matrix [K_{D}^{e}] of the element in the orthogonal principle-curve coordinate system after the displacement extension, namely

$$[ {K}_{T}^{e} ] = \{ \begin{matrix}I \\ {T}_{R}^{T}\end{matrix} \} [ {K}_{D}^{e} ] \{ \begin{matrix}I & {T}_{R}\end{matrix} \} = [ \begin{matrix}{K}_{11} & {K}_{12} \\ {K}_{21} & {K}_{22}\end{matrix} ] ;$$

wherein:

[K₁₁]_{40×40}=[K_{D}^{e}],[K₁₂]_{40×6}=[K₂₁]^{T}=[K_{D}^{e}][T_{R}][K₂₂]_{6×6}=[T_{R}]_{T}[K_{D}^{e}][T_{R}];

{V_{R}}=[K₂₂]⁻¹[K₂₁]{δ_{T}^{e}},{P_{D}^{e}}=([K₁₁]−[K₁₂][K₂₂]⁻¹[K₁₂]){δ_{T}^{e}};

{εₑ}=[B]*{δ_{T}^{e}},[B]*([I]−[T_{R}][K₂₂]⁻¹[K₂₁];

the transformation relation between the stiffness matrix and the load vector in the global coordinate system is that:

[K′^{e}]=[T][K_{T}^{e}][T]^{T},[P′]^{e}=[T][P′_{D}^{e}];

and through integrating the stiffness matrix and the load vector of each element in the global coordinate system, the node displacement solving equation of the global coordinate system is obtained.

In the orthogonal principle-curve coordinate system of (α,β,δ), α,β,δ are arc lengths of the curvilinear coordinates. For any eight-node quadrilateral element, based on the creative method of combining the linear transformation coordinate system with the isoparametric coordinate system, the curvilinear arc length coordinates are processed with the linear coordinate transformation and the isoparametric coordinate transformation as the planar thin-plate problem, and the element displacement interpolation function is assumed to be:

$$\{ \begin{matrix}u ( v ) = {a}_{1} + {a}_{2} {T}_{1} + {a}_{3} {T}_{2} + {a}_{4} {T}_{1}^{2} + {a}_{5} {T}_{1} {T}_{2} + {a}_{6} {T}_{2}^{2} + {a}_{7} {ξ}^{2} η + {a}_{8} {ξη}^{2} \\ \begin{matrix}w = {a}_{1} + {a}_{2} {T}_{1} + {a}_{3} {T}_{2} + {a}_{4} {T}_{1}^{2} + {a}_{5} {T}_{1} {T}_{2} + {a}_{6} {T}_{2}^{2} + {a}_{7} {T}_{1}^{3} + {a}_{8} {T}_{1}^{2} {T}_{2} + \\ {a}_{9} {T}_{1} {T}_{2}^{2} + {a}_{10} {T}_{2}^{3} + {a}_{11} {T}_{1}^{4} + {a}_{12} {T}_{1}^{3} {T}_{2} + {a}_{13} {T}_{1}^{2} {T}_{2}^{2} + {a}_{14} {T}_{1} {T}_{2}^{3} + {a}_{15} {T}_{2}^{4} + \\ {a}_{16} {T}_{1}^{5} + {a}_{17} {T}_{1}^{4} {T}_{2} + {a}_{18} {T}_{1}^{3} {T}_{2}^{2} + {a}_{19} {T}_{1}^{2} {T}_{2}^{3} + {a}_{20} {T}_{1} {T}_{2}^{4} + {a}_{21} {T}_{2}^{5} + {a}_{22} {ξ}^{4} {η}^{2} + \\ {a}_{23} {ξ}^{3} {η}^{3} + {a}_{24} {ξ}^{2} {η}^{4}\end{matrix} .\end{matrix}$$

An equation set is established according to the element node displacements, and undetermined coefficients are determined through the simultaneous solution. The constructed interpolation function has the fifth-order completeness, which is relatively high and suitable for the curvilinear boundary. When element dividing, it is merely required that the common boundary of the two adjacent elements is kept to be a straight line and nodes in the boundary equally divide the boundary, without any compatibility requirement on free outer boundary of the element that the free outer boundary can be a curve, so as to be suitable for the curvilinear boundary. At the moment, the element displacement interpolation function has the compatible deflection and tangential corner at the common boundary of the element, while the normal corner thereof is incompatible and required to be modified.

When the common boundary of two adjacent elements is a straight line and the nodes in the boundary equally divide the boundary, the element displacement interpolation function has the compatible deflection and tangential corner at the element boundary. However, the normal corner of the element displacement interpolation function is incompatible, which is namely the C¹-order non-compatibility problem and considered as the unsolvable difficult problem for more than a century. Therefore, according to the preferred embodiment, in the regular isoparametric coordinate system, a specific modified function modifies the incompatible normal corner of only one boundary of the element, without affecting the deflections and the tangential corner values of the other boundaries of the element, and more importantly, without affecting the normal corner values of the other boundaries of the element. Thus, merely the incompatible normal corner at the common boundary of the element is required to be modified, and the incompatible normal corner at the free boundary of the element is not required to be modified. The outer boundary of the element can be a curve, so as to be suitable for the curvilinear boundary.

Through the theoretical analysis, it is firstly proposed that the incompatible normal corner displacement at the boundary of the element is modified through the following equation of:

$$Δ w = - \frac{( 1 - {η}^{2} ) ( 1 + ξ ) {( 1 - ξ )}^{2}}{4 ( 2 + ξ + η ) ( 2 + ξ - η )} {Δθ}_{η23} ( η ) + \frac{( 1 - {η}^{2} ) ( 1 - ξ ) {( 1 + ξ )}^{2}}{4 ( 2 - ξ + η ) ( 2 - ξ - η )} {Δθ}_{η14} ( η ) + \frac{( 1 - {ξ}^{2} ) ( 1 + η ) {( 1 - η )}^{2}}{4 ( 2 + ξ + η ) ( 2 - ξ + η )} {Δθ}_{η34} ( ξ ) - \frac{( 1 - {ξ}^{2} ) ( 1 - η ) {( 1 + η )}^{2}}{4 ( 2 + ξ - η ) ( 2 - ξ - η )} {Δθ}_{η12} ( ξ ) ;$$

$$wherein \text{:}$$

Δθ_{η23}(η), Δθ_{η14}(η), Δθ_{ξ34}(ξ) and Δθ_{ξ12}(ξ) are the incompatible normal corner displacements of four boundaries of the element, which are zero at the node; and the incompatible normal corner displacement of any boundary of the element can be selectively modified.

In conclusion, according to the preferred embodiment, based on the hybrid coordinate system formed by the linear transformation coordinate system and the isoparametric coordinate system, not based on the single coordinate system, the interpolation function for solving the physical quantities is constructed, which enables the calculation accuracy of the finite element analysis software to be greatly increased, improves the safety reliability of the structural design and optimizes the structural design; the constructed interpolation function becomes more suitable for various curved-surface (curvilinear) boundary, thereby bringing great economic benefit to the construction of engineering, aviation and aerospace.

The above-described is only the preferred embodiment of the present invention, not for limiting the present invention. For one skilled in the art, the present invention is able to have various modifications and changes. Therefore, all modifications, equivalent replacements and improvements encompassed within the spirit and scope of the following claims are included in the protection range of the present invention.

1: A method for constructing a finite element interpolation method, comprising steps of:
constructing an interpolation function through a hybrid coordinate system formed by a linear transformation coordinate system and an isoparametric coordinate system; and
according to characteristics of a target solid element, determining a coordinate variable number, a term number and an order of the interpolation function, wherein: the characteristics of the target solid element comprise a known node number and a known node displacement component number; the term number of the constructed interpolation function is equal to a total displacement number of related interpolation nodes of the target solid element; meanwhile, a part corresponding to the linear transformation coordinate system in the constructed interpolation function is a highest-order complete polynomial with orders of every term progressively increasing from low to high after covering every coordinate variable combination; and, in a highest order of the part corresponding to the linear transformation coordinate system, orders of every term of a part corresponding to the isoparametric coordinate system in the constructed interpolation function increase progressively from low to high after covering every coordinate variable combination and are distributed symmetrically.

2: The method for constructing the finite element interpolation function, as recited in claim 1, wherein the constructed interpolation function comprises at least one of following items that:
1) when the target solid element is a two-dimensional eight-node high-order complete compatible quadrilateral curved element, the constructed element displacement interpolation function is that:
u(v)=a₁+a₂T₁+a₃T₂+a₄T₁²+a₅T₁T₂+a₆T₂²+a₇ξ²η+a₈ξη²
2) when the target solid element is a two-dimensional twelve-node high-order complete compatible quadrilateral curved element, the constructed element displacement interpolation function is that:
u(v)=a₁+a₂T₁+a₃T₂+a₄T₁²+a₅T₁T₂+a₆T₂²+a₇T₁³+a₈T₁²T₂+a₉T₁T₂²+a₁₀T₂³+a₁₁ξ³η+a₁₂ξη³;
3) when the target solid element is a three-dimensional twenty-node high-order complete compatible curved-surface hexahedral element, the constructed element displacement interpolation function is that:
u(v,w)=a₁+a₂T₁+a₃T₂+a₄T₃+a₅T₁²+a₆T₂²+a₇T₃²+a₈T₁T₂+a₉T₁T₂+a₁₀T₂T₃+a₁₁ξ²ηζ+a₁₂ξ²ζ+a₁₃ξη²+a₁₄η²ζ+a₁₅ξζ²+a₁₆ηζ²+a₁₇ξηζ+a₁₈ξ²ηζ+a₁₉ξη²ζ+a₂₀ξηζ²;
4) when the target solid element is a three-dimensional thirty-two-node high-order complete compatible curved-surface hexahedral element, the constructed element displacement interpolation function is that:
u(v,w)=a₁+a₂T₁+a₃T₂+a₄T₃+a₅T₁²+a₆T₂²+a₇T₃²+a₈T₁T₂+a₉T₁T₃a+a₁₀T₂T₃a₁₁T₁³+a₁₂T₂³+a₁₃T₃³+a₁₄T₁²T₂+a₁₅T₁²T₃+a₁₆T₁T₂²+a₁₇T₂²T₃+a₁₈T₁T₃²+a₁₉T₂T₃²+a₂₀T₁T₂T₃+a₂₁ξ³ηζ+a₂₂ξ³ζ+a₂₃ξη³+a₂₄η³ζ+a₂₅ξζ³+a₂₆ηζ³+a₂₇ξ²ηζ+a₂₈ξη²ζ+a₂₉ξηζ²+a₃₀ξ²η²+a₃₁ξ²ζ²+a₃₂η²ζ²
5) when the target solid element is a two-dimensional four-node high-order complete compatible quadrilateral thin-plate element with every node having three related displacement components of w,θₓ,θ_{y}, the constructed element displacement interpolation function is that:
w=a₁+a₂T₁+a₃T₂+a₄T₁²+a₅T₁T₂+a₆T₂²+a₇T₁³+a₈T₁²T₂+a₉T₁T₂²+a₁₀T₂³+a₁₁ξ³η+a₁₂ξη³;
6) when the target solid element is a two-dimensional eight-node high-order complete compatible curved quadrilateral thin-plate element with every node having three related displacement components of w,θₓ,θ_{y}, the constructed element displacement interpolation function is that:
w=a₁+a₂T₁+a₃T₂+a₄T₁²+a₅T₁T₂+a₆T₂²+a₇T₁³+a₈T₁²T₂+a₉T₁T₂²+a₁₀T₂³+a₁₁T₁⁴+a₁₂T₁³T₂+a₁₃T₁²T₂²+a₁₄T₁T₂³+a₁₅T₂⁴+a₁₆T₁⁵+a₁₇T₁⁴T₂+a₁₈T₁³T₂²+a₁₉T₁²T₂³+a₂₀T₁T₂⁴+a₂₁T₂⁵+a₂₂ξ⁴η²+a₂₃ξ³η³+a₂₄ξ²η⁴
wherein: in the above equations, T₁, T₂ and T₃ are respectively coordinate axes of the linear transformation coordinate system in an element curved-surface; ξ, η and ζ are respectively coordinate axes of the isoparametric coordinate system; u, v and w respectively correspond to displacements on three local coordinate directions in the element curved-surface; θₓ and θ_{y} are partial derivatives of w respectively with respect to x and Y in the element curved-surface, and θ_{xy} is a second-order cross partial derivative of w with respect to x and y.

3: The method for constructing the finite element interpolation function, as recited in claim 1, wherein: for a conventional spatial thin-shell adopted in engineering, suitable orthogonal curvilinear coordinates and a corresponding geometric equation are adopted; according to the above-described principle, as a planar problem, a high-order complete compatible curved-surface thin-shell element is directly constructed in a spatial orthogonal curvilinear coordinate system; then an element stiffness matrix is calculated, and spatial coordinate transformation is implemented; and detailed conditions are described that:
1) when the target solid element is a three-dimensional four-node high-order complete compatible quadrilateral flat-plate thin-shell element with every node having three related displacement components of w,θₓ,θ_{y}, the constructed element displacement interpolation function is that:
$$\{ \begin{matrix}u ( v ) = {a}_{1} + {a}_{2} {T}_{1} + {a}_{3} {T}_{2} + {a}_{4} ξη \\ \begin{matrix}w = {a}_{1} + {a}_{2} {T}_{1} + {a}_{3} {T}_{2} + {a}_{4} {T}_{1}^{2} + {a}_{5} {T}_{1} {T}_{2} + {a}_{6} {T}_{2}^{2} + {a}_{7} {T}_{1}^{3} + \\ {a}_{8} {T}_{1}^{2} {T}_{2} + {a}_{9} {T}_{1} {T}_{2}^{2} + {a}_{10} {T}_{2}^{3} + {a}_{11} {ξ}^{3} η + {a}_{12} {ξη}^{3}\end{matrix}\end{matrix}$$
2) when the target solid element is a three-dimensional eight-node high-order complete compatible curvilinear quadrilateral flat-plate thin-shell element with every node having three related displacement components of w,θₓ,θ_{y}, the constructed element displacement interpolation function is that:
$$\{ \begin{matrix}u ( v ) = {a}_{1} + {a}_{2} {T}_{1} + {a}_{3} {T}_{2} + {a}_{4} {T}_{1}^{2} + {a}_{5} {T}_{1} {T}_{2} + {a}_{6} {T}_{2}^{2} + {a}_{7} {ξ}^{2} η + {a}_{8} {ξη}^{2} \\ \begin{matrix}w = {a}_{1} + {a}_{2} {T}_{1} + {a}_{3} {T}_{2} + {a}_{4} {T}_{1}^{2} + {a}_{5} {T}_{1} {T}_{2} + {a}_{6} {T}_{2}^{2} + {a}_{7} {T}_{1}^{3} + {a}_{8} {T}_{1}^{2} {T}_{2} + \\ {a}_{9} {T}_{1} {T}_{2}^{2} + {a}_{10} {T}_{2}^{3} + {a}_{11} {T}_{1}^{4} + {a}_{12} {T}_{1}^{3} {T}_{2} + {a}_{13} {T}_{1}^{2} {T}_{2}^{2} + {a}_{14} {T}_{1} {T}_{2}^{3} + {a}_{15} {T}_{2}^{4} + \\ {a}_{16} {T}_{1}^{5} + {a}_{17} {T}_{1}^{4} {T}_{2} + {a}_{18} {T}_{1}^{3} {T}_{2}^{2} + {a}_{19} {T}_{1}^{2} {T}_{2}^{3} + {a}_{20} {T}_{1} {T}_{2}^{4} + {a}_{21} {T}_{2}^{5} + {a}_{22} {ξ}^{4} {η}^{2} + \\ {a}_{23} {ξ}^{3} {η}^{3} + {a}_{24} {ξ}^{2} {η}^{4}\end{matrix}\end{matrix}$$
3) when the target solid element is a three-dimensional four-node high-order complete compatible quadrilateral curved-surface thin-shell element with every node having three related displacement components of w,θₓ,θ_{y}, the constructed element displacement interpolation function is that:
$$\{ \begin{matrix}u ( v ) = {a}_{1} + {a}_{2} {T}_{1} + {a}_{3} {T}_{2} + {a}_{4} ξη \\ \begin{matrix}w = {a}_{1} + {a}_{2} {T}_{1} + {a}_{3} {T}_{2} + {a}_{4} {T}_{1}^{2} + {a}_{5} {T}_{1} {T}_{2} + {a}_{6} {T}_{2}^{2} + {a}_{7} {T}_{1}^{3} + \\ {a}_{8} {T}_{1}^{2} {T}_{2} + {a}_{9} {T}_{1} {T}_{2}^{2} + {a}_{10} {T}_{2}^{3} + {a}_{11} {ξ}^{3} η + {a}_{12} {ξη}^{3}\end{matrix}\end{matrix}$$
4) when the target solid element is a three-dimensional eight-node high-order complete compatible quadrilateral curved-surface thin-shell element with every node having three related displacement components of w,θₓ,θ_{y}, the constructed element displacement interpolation function is that:
$$\{ \begin{matrix}u ( v ) = {a}_{1} + {a}_{2} {T}_{1} + {a}_{3} {T}_{2} + {a}_{4} {T}_{1}^{2} + {a}_{5} {T}_{1} {T}_{2} + {a}_{6} {T}_{2}^{2} + {a}_{7} {ξ}^{2} η + {a}_{8} {ξη}^{2} \\ \begin{matrix}w = {a}_{1} + {a}_{2} {T}_{1} + {a}_{3} {T}_{2} + {a}_{4} {T}_{1}^{2} + {a}_{5} {T}_{1} {T}_{2} + {a}_{6} {T}_{2}^{2} + {a}_{7} {T}_{1}^{3} + {a}_{8} {T}_{1}^{2} {T}_{2} + \\ {a}_{9} {T}_{1} {T}_{2}^{2} + {a}_{10} {T}_{2}^{3} + {a}_{11} {T}_{1}^{4} + {a}_{12} {T}_{1}^{3} {T}_{2} + {a}_{13} {T}_{1}^{2} {T}_{2}^{2} + {a}_{14} {T}_{1} {T}_{2}^{3} + {a}_{15} {T}_{2}^{4} + \\ {a}_{16} {T}_{1}^{5} + {a}_{17} {T}_{1}^{4} {T}_{2} + {a}_{18} {T}_{1}^{3} {T}_{2}^{2} + {a}_{19} {T}_{1}^{2} {T}_{2}^{3} + {a}_{20} {T}_{1} {T}_{2}^{4} + {a}_{21} {T}_{2}^{5} + {a}_{22} {ξ}^{4} {η}^{2} + \\ {a}_{23} {ξ}^{3} {η}^{3} + {a}_{24} {ξ}^{2} {η}^{4}\end{matrix}\end{matrix}$$
wherein: in the above equations, T₁, T₂ and T₃ are respectively coordinate axes of the linear transformation coordinate system in an element curved-surface; ξ, η and ζ are respectively coordinate axes of the isoparametric coordinate system; u, v and w respectively correspond to displacements on three local coordinate directions in the element curved-surface; θₓ and θ_{y} are partial derivatives of w respectively with respect to x and Y in the element curved-surface, and θ_{xy} is a second-order cross partial derivative of w with respect to x and y.

4: The method for constructing the finite element interpolation function, as recited in claim 3, wherein: for the shell element on the curvilinear coordinate system, a complete rigid-body displacement is supplemented in a displacement mode.

5-7. (canceled)

8: The method for constructing the finite element interpolation function, as recited in claim 1, wherein:
when the target solid element is a two-dimensional four-node high-order complete compatible quadrilateral thin-plate element, a two-dimensional eight-node high-order complete compatible curved quadrilateral thin-plate element, a three-dimensional four-node high-order complete compatible quadrilateral flat-plate thin-shell element, a three-dimensional eight-order high-order complete compatible curved quadrilateral flat-plate thin-shell element, a three-dimensional four-node high-order complete compatible quadrilateral curved-surface thin-shell element or a three-dimensional eight-node high-order complete compatible quadrilateral curved-surface thin-shell element with every node merely having three related displacement components, an incompatible normal corner displacement at a boundary of the element is modified through a following equation of:
$$Δ w = - \frac{( 1 - {η}^{2} ) ( 1 + ξ ) {( 1 - ξ )}^{2}}{4 ( 2 + ξ + η ) ( 2 + ξ - η )} {Δθ}_{η23} ( η ) + \frac{( 1 - {η}^{2} ) ( 1 - ξ ) {( 1 + ξ )}^{2}}{4 ( 2 - ξ + η ) ( 2 - ξ - η )} {Δθ}_{η14} ( η ) + \frac{( 1 - {ξ}^{2} ) ( 1 + η ) {( 1 - η )}^{2}}{4 ( 2 + ξ + η ) ( 2 - ξ + η )} {Δθ}_{η34} ( ξ ) - \frac{( 1 - {ξ}^{2} ) ( 1 - η ) {( 1 + η )}^{2}}{4 ( 2 + ξ - η ) ( 2 - ξ - η )} {Δθ}_{η12} ( ξ ) ;$$
wherein Δθ_{η23}(η), Δθ_{η14}(η), Δθ_{ξ34}(ξ) and Δθ_{ξ12}(ξ) are the incompatible normal corner displacements of four boundaries of the element, which are zero at the node.

9: The method for constructing the finite element interpolation function, as recited in claim 2, wherein:
when the target solid element is a two-dimensional four-node high-order complete compatible quadrilateral thin-plate element, a two-dimensional eight-node high-order complete compatible curved quadrilateral thin-plate element, a three-dimensional four-node high-order complete compatible quadrilateral flat-plate thin-shell element, a three-dimensional eight-order high-order complete compatible curved quadrilateral flat-plate thin-shell element, a three-dimensional four-node high-order complete compatible quadrilateral curved-surface thin-shell element or a three-dimensional eight-node high-order complete compatible quadrilateral curved-surface thin-shell element with every node merely having three related displacement components, an incompatible normal corner displacement at a boundary of the element is modified through a following equation of:
$$Δ w = - \frac{( 1 - {η}^{2} ) ( 1 + ξ ) {( 1 - ξ )}^{2}}{4 ( 2 + ξ + η ) ( 2 + ξ - η )} Δ {θ}_{η 23} ( η ) + \frac{( 1 - {η}^{2} ) ( 1 - ξ ) {( 1 + ξ )}^{2}}{4 ( 2 - ξ + η ) ( 2 - ξ - η )} Δ {θ}_{η 14} ( η ) + \frac{( 1 - {ξ}^{2} ) ( 1 + η ) {( 1 - η )}^{2}}{4 ( 2 + ξ + η ) ( 2 - ξ + η )} Δ {θ}_{ξ 34} ( ξ ) - \frac{( 1 - {ξ}^{2} ) ( 1 - η ) {( 1 + η )}^{2}}{4 ( 2 + ξ - η ) ( 2 - ξ - η )} Δ {θ}_{ξ 12} ( ξ ) ;$$
wherein Δθ_{η23}(η), Δθ_{η14}(η), Δθ_{ξ34}(ξ) and Δθ_{ξ12}(ξ) are the incompatible normal corner displacements of four boundaries of the element, which are zero at the node.

10: The method for constructing the finite element interpolation function, as recited in claim 3, wherein:
when the target solid element is a two-dimensional four-node high-order complete compatible quadrilateral thin-plate element, a two-dimensional eight-node high-order complete compatible curved quadrilateral thin-plate element, a three-dimensional four-node high-order complete compatible quadrilateral flat-plate thin-shell element, a three-dimensional eight-order high-order complete compatible curved quadrilateral flat-plate thin-shell element, a three-dimensional four-node high-order complete compatible quadrilateral curved-surface thin-shell element or a three-dimensional eight-node high-order complete compatible quadrilateral curved-surface thin-shell element with every node merely having three related displacement components, an incompatible normal corner displacement at a boundary of the element is modified through a following equation of:
$$Δ w = - \frac{( 1 - {η}^{2} ) ( 1 + ξ ) {( 1 - ξ )}^{2}}{4 ( 2 + ξ + η ) ( 2 + ξ - η )} Δ {θ}_{η 23} ( η ) + \frac{( 1 - {η}^{2} ) ( 1 - ξ ) {( 1 + ξ )}^{2}}{4 ( 2 - ξ + η ) ( 2 - ξ - η )} Δ {θ}_{η 14} ( η ) + \frac{( 1 - {ξ}^{2} ) ( 1 + η ) {( 1 - η )}^{2}}{4 ( 2 + ξ + η ) ( 2 - ξ + η )} Δ {θ}_{ξ 34} ( ξ ) - \frac{( 1 - {ξ}^{2} ) ( 1 - η ) {( 1 + η )}^{2}}{4 ( 2 + ξ - η ) ( 2 - ξ - η )} Δ {θ}_{ξ 12} ( ξ ) ;$$
wherein Δθ_{η23}(η), Δθ_{η14}(η), Δθ_{ξ34}(ξ) and Δθ_{ξ12}(ξ) are the incompatible normal corner displacements of four boundaries of the element, which are zero at the node.

11: The method for constructing the finite element interpolation function, as recited in claim 4, wherein:
when the target solid element is a two-dimensional four-node high-order complete compatible quadrilateral thin-plate element, a two-dimensional eight-node high-order complete compatible curved quadrilateral thin-plate element, a three-dimensional four-node high-order complete compatible quadrilateral flat-plate thin-shell element, a three-dimensional eight-order high-order complete compatible curved quadrilateral flat-plate thin-shell element, a three-dimensional four-node high-order complete compatible quadrilateral curved-surface thin-shell element or a three-dimensional eight-node high-order complete compatible quadrilateral curved-surface thin-shell element with every node merely having three related displacement components, an incompatible normal corner displacement at a boundary of the element is modified through a following equation of:
$$Δ w = - \frac{( 1 - {η}^{2} ) ( 1 + ξ ) {( 1 - ξ )}^{2}}{4 ( 2 + ξ + η ) ( 2 + ξ - η )} Δ {θ}_{η 23} ( η ) + \frac{( 1 - {η}^{2} ) ( 1 - ξ ) {( 1 + ξ )}^{2}}{4 ( 2 - ξ + η ) ( 2 - ξ - η )} Δ {θ}_{η 14} ( η ) + \frac{( 1 - {ξ}^{2} ) ( 1 + η ) {( 1 - η )}^{2}}{4 ( 2 + ξ + η ) ( 2 - ξ + η )} Δ {θ}_{ξ 34} ( ξ ) - \frac{( 1 - {ξ}^{2} ) ( 1 - η ) {( 1 + η )}^{2}}{4 ( 2 + ξ - η ) ( 2 - ξ - η )} Δ {θ}_{ξ 12} ( ξ ) ;$$
wherein Δθ_{η23}(η), Δθ_{η14}(η), Δθ_{ξ34}(ξ) and Δθ_{ξ12}(ξ) are the incompatible normal corner displacements of four boundaries of the element, which are zero at the node.

12: The method for constructing the finite element interpolation function, as recited in claim 8, wherein: a transformation equation between the global coordinate system and the linear transformation coordinate system has following conditions that:
in a two-dimensional condition,
$$\{ \begin{matrix}{T}_{1} = {o}_{1} x + {b}_{1} y + {c}_{1} \\ {T}_{2} = {o}_{2} x + {b}_{2} y + {c}_{2}\end{matrix} ;$$
six undetermined coefficients oᵢ,bᵢ,cᵢ, (i=1,2) exist in the coordinate transformation relation, which are determined by an equation set having six linear transformation coordinate values of 0 or 1; and
in a three-dimensional condition,
$$\{ \begin{matrix}{T}_{1} = {o}_{1} x + {b}_{1} y + {c}_{1} z + {d}_{1} \\ {T}_{2} = {o}_{2} x + {b}_{2} y + {c}_{2} z + {d}_{2} \\ {T}_{3} = {o}_{3} x + {b}_{3} y + {c}_{3} z + {d}_{3}\end{matrix} ;$$
undetermined coefficients oᵢ,bᵢ,cᵢdᵢ, (i=1,2,3) exist in the coordinate transformation relation, which are determined by an equation set having twelve linear coordinate values of 0 or 1.

13: The method for constructing the finite element interpolation function, as recited in claim 9, wherein: a transformation equation between the global coordinate system and the linear transformation coordinate system has following conditions that:
in a two-dimensional condition,
$$\{ \begin{matrix}{T}_{1} = {o}_{1} x + {b}_{1} y + {c}_{1} \\ {T}_{2} = {o}_{2} x + {b}_{2} y + {c}_{2}\end{matrix} ;$$
six undetermined coefficients oᵢ,bᵢ,cᵢ, (i=1,2) exist in the coordinate transformation relation, which are determined by an equation set having six linear transformation coordinate values of 0 or 1; and
in a three-dimensional condition,
$$\{ \begin{matrix}{T}_{1} = {o}_{1} x + {b}_{1} y + {c}_{1} z + {d}_{1} \\ {T}_{2} = {o}_{2} x + {b}_{2} y + {c}_{2} z + {d}_{2} \\ {T}_{3} = {o}_{3} x + {b}_{3} y + {c}_{3} z + {d}_{3}\end{matrix} ;$$
twelve undetermined coefficients oᵢ,bᵢ,cᵢ,dᵢ, (i=1,2,3) exist in the coordinate transformation relation, which are determined by an equation set having twelve linear coordinate values of 0 or 1.

14: The method for constructing the finite element interpolation function, as recited in claim 10, wherein: a transformation equation between the global coordinate system and the linear transformation coordinate system has following conditions that:
in a two-dimensional condition,
$$\{ \begin{matrix}{T}_{1} = {o}_{1} x + {b}_{1} y + {c}_{1} \\ {T}_{2} = {o}_{2} x + {b}_{2} y + {c}_{2}\end{matrix} ;$$
six undetermined coefficients oᵢ,bᵢ,cᵢ, (i=1,2) exist in the coordinate transformation relation, which are determined by an equation set having six linear transformation coordinate values of 0 or 1; and
in a three-dimensional condition,
$$\{ \begin{matrix}{T}_{1} = {o}_{1} x + {b}_{1} y + {c}_{1} z + {d}_{1} \\ {T}_{2} = {o}_{2} x + {b}_{2} y + {c}_{2} z + {d}_{2} \\ {T}_{3} = {o}_{3} x + {b}_{3} y + {c}_{3} z + {d}_{3}\end{matrix} ;$$
twelve undetermined coefficients oᵢ,bᵢ,cᵢ, dᵢ, (i=1,2,3) exist in the coordinate transformation relation, which are determined by an equation set having twelve linear coordinate values of 0 or 1.

15: The method for constructing the finite element interpolation function, as recited in claim 11, wherein: a transformation equation between the global coordinate system and the linear transformation coordinate system has following conditions that:
in a two-dimensional condition,
$$\{ \begin{matrix}{T}_{1} = {o}_{1} x + {b}_{1} y + {c}_{1} \\ {T}_{2} = {o}_{2} x + {b}_{2} y + {c}_{2}\end{matrix} ;$$
six undetermined coefficients oᵢ,bᵢ,cᵢ, (i=1,2) exist in the coordinate transformation relation, which are determined by an equation set having six linear transformation coordinate values of 0 or 1; and
in a three-dimensional condition,
$$\{ \begin{matrix}{T}_{1} = {o}_{1} x + {b}_{1} y + {c}_{1} z + {d}_{1} \\ {T}_{2} = {o}_{2} x + {b}_{2} y + {c}_{2} z + {d}_{2} \\ {T}_{3} = {o}_{3} x + {b}_{3} y + {c}_{3} z + {d}_{3}\end{matrix} ;$$
twelve undetermined coefficients oᵢ,bᵢ,cᵢ,dᵢ, (i=1,2,3) exist in the coordinate transformation relation, which are determined by an equation set having twelve linear coordinate values of 0 or 1.

16: The method for constructing the finite element interpolation function, as recited in claim 8, wherein a transformation equation between the global coordinate system and the isoparametric coordinate system is that:
$$\{ \begin{matrix}x \\ y \\ z\end{matrix} \} = {\sum }_{i = 1}^{n} {N}_{i} ( ξ ) [ \begin{matrix}{x}_{i} \\ {y}_{i} \\ {z}_{i}\end{matrix} ] .$$

17: The method for constructing the finite element interpolation function, as recited in claim 9, wherein a transformation equation between the global coordinate system and the isoparametric coordinate system is that:
$$\{ \begin{matrix}x \\ y \\ z\end{matrix} \} = {\sum }_{i = 1}^{n} {N}_{i} ( ξ ) [ \begin{matrix}{x}_{i} \\ {y}_{i} \\ {z}_{i}\end{matrix} ] .$$

18: The method for constructing the finite element interpolation function, as recited in claim 10, wherein a transformation equation between the global coordinate system and the isoparametric coordinate system is that:
$$\{ \begin{matrix}x \\ y \\ z\end{matrix} \} = {\sum }_{i = 1}^{n} {N}_{i} ( ξ ) [ \begin{matrix}{x}_{i} \\ {y}_{i} \\ {z}_{i}\end{matrix} ] .$$

19: The method for constructing the finite element interpolation function, as recited in claim 11, wherein a transformation equation between the global coordinate system and the isoparametric coordinate system is that:
$$\{ \begin{matrix}x \\ y \\ z\end{matrix} \} = {\sum }_{i = 1}^{n} {N}_{i} ( ξ ) [ \begin{matrix}{x}_{i} \\ {y}_{i} \\ {z}_{i}\end{matrix} ] .$$
